(19) United States
(12) Patent Application Publication
(10) Pub. No.: US 2013/0101792 A1
(43) Pub. Date: Apr. 25, 2013

(54) METHOD AND APPARATUS FOR PRODUCING A NANOSTRUCTURED OR SMOOTH POLYMER ARTICLE

(71) Applicant: Henrik Pranov, Espergaerde (DK)

(72) Inventor: Henrik Pranov, Espergaerde (DK)

(73) Assignee: InMold Biosystems A/S, Taastrup (DK)

(21) Appl. No.: 13/806,518

(22) PCT Filed: Jun. 29, 2011
(86) PCT No.: PCT/DK2011/000075

§ 371 Date: Dec. 21, 2012

(30) Foreign Application Priority Data
Jul. 1, 2010 (DK) PA-2010 00581

(51) Int. Cl. B29C 33/38

(52) U.S. Cl. CPC B29C 33/3842
USPC 428/141; 264/225; 264/430; 264/523

(57) ABSTRACT

The present invention solves numerous problems in state-of-the-art industrial polymer shaping of micro and nanostructures. The problems of high tool polishing requirements, the inability to define an arbitrary topographical structure on an arbitrary free-form (curved) surface, limited durability and replication quality, as well as providing a convenient method for functionalizing the surface. The invention solves these problems by deploying a ceramic material precursor, which may be coated onto a conventional polymer shaping tool, micro- or nanostructured by mechanical contact (embossing), cured into a hard, durable ceramic material comprising the desired structures. The ceramic material is functionalisable by silane chemistry, due to its high surface density of —OH groups. This apparatus may then be used in a conventional polymer shaping process to make nanostructured polymer replicas.

### BACKGROUND OF THE INVENTION

In biotechnological, medical and consumer applications, it is desirable to apply functional structures e.g. nanostructures, to defined areas of articles for use as functional or decorative surfaces or as means of identification. A method of producing such articles independently of the overall macro-geometry is desirable, in particular if such articles are mass produced at a relative low price as many of these articles must be disposable or low cost reusable products, e.g. toys or packaging material.

Non-limiting examples of functional micro or nanostructures are self-cleaning surfaces, optical diffraction gratings, holograms, photonic crystals, digital media information, biological function inducing structures, 3D cell culture, steric recognizable structures, hydrophilicity influencing structures, or the absence of random structures caused by surface roughness, namely a nanoscopically smooth surface.

Today, injection molded nanostructured materials are widely used for information storage in the CD/DVD/Blu-Ray industry, although only in a macroscopic flat geometry. Furthermore, the durability of the injection molding masters is limited to 10.000-100.000 replications, where the replica quality slowly decreases from the first replica to the final replica due to wear of the master nanostructure. The master structures are typical made by the LIGA process, where a first master is made by lithographic methods, and a second inverted master is made by galvanoforming of the first master. The second master is then used as an injection molding insert. Due to the precision demands of the lithographic methods involved, the geometry is restricted to be flat, and the master material is restricted to materials that may be deposited by galvanoforming, most often nickel, copper and cobalt. These materials are ductile materials that are vulnerable to wear and small deformations during the injection molding process, and hence only have limited durability as injection molding insert.

Other planar geometries being manufactured today are research nanostructures made by technologies such as hot embossing or nano imprint lithography (NIL). In these technologies, a highly polished and planar substrate, typically silicon or glass wafers, are coated with a substance to be structured. The substance to be structured are typically an organic substance such as a photoresist or e-beam resist, but also inorganic substances as hydrogen silsesquioxane (HSQ) has been structured by both e-beam lithography and NIL. The structured surface may then be embossed in a liquid polymer that may then be solidified by either cooling it down (e.g. a molten thermoplastic polymer used in hot embossing) or cross-linking it (e.g. a UV-reactive polymer used in step and flash NIL). These methods rely on the extreme low surface roughness of silicon or glass wafers. However, silicon and glass wafers are not suitable for use in methods such as injection molding, compression molding, blow molding where the mold or primary nanostructure is kept colder than the solidification temperature of the polymer during the process, and high pressures and injection velocities are required to fill the nanostructures. As the silicon and glass substrates are very brittle, application in these processes will cause the silicon or glass substrates to break during injection of the molten polymer. A further problem is, as previously mentioned, that these methods are restricted to planar surfaces. It would therefore be preferable if such tools could be manufactured in stronger and more durable materials such as steel. However, to define nanostructures in a tool surface, the surface roughness of the tool needs to be lower than the size of the desired nanostructures. Furthermore, the traditional gas or vacuum based methods to manufacture nanostructures, such as Reactive Ion Etching, Plasma Assisted Etching or Laser Assisted Etching are not applicable to steel, as the main components of steel cannot be turned into a gaseous molecule. Even lower durability metals, such as aluminum that may be dry-etched will suffer from the disadvantage that it is not possible to form an arbitrary 3D structure, as the dry-etched areas will define a lower topographical level of the nanostructure, whereas the un-etched areas will define an upper topographical level, thus giving rise to a two-level structure with steep slopes in between. The same kind of restrictions in obtainable geometry also counts for both isotropic and anisotropic etching; by isotropic etching the obtainable geometry will be half-spherical and by anisotropic etching the geometry will in general depend on the crystalline structure of the material etched. Isotropic wet Chemical Etching of steel is possible, but resolution will be limited by the grain structure of the steel as well as being limited to half-spherical structures due to the isotropic nature of the etching.

Due to the abovementioned problems with the state-of-the-art, it would be desirable to have a technological solution, where durable micro or nanostructures may be applied directly to existing polymer shaping tools with a relative high surface roughness. It would also be preferable if this solution could be provided on free-form curved surfaces with true 3D nanostructures. It would be further advantageous if this solution could provide a thin thermal insulating (compared to metals) layer in order to increase the time to solidification of the polymer melt, providing a better replication of the micro or nanostructures. A further advantage would be if the surface provided by this solution where a surface capable of being chemically modified in order to either increase the surface energy to the molten polymer, and/or to provide a surface modification improving the release of the solidified polymer. A further advantage would be if the solution would also increase the lifetime of the tool.

To overcome the abovementioned problems of state-of-the-art an invention providing the technological solution with the abovementioned desired properties is here presented.

In order to obtain curved surfaces, today CNC milling, electric discharge machining or wire cutting of the surfaces are the most widely used methods. The precision of these techniques are at the order of 10-100 μm and therefore not suitable to manufacture nanostructures, and they do furthermore typically result in surface roughness defined as Rz in the literature on the order of 1-10 μm or more.

It is well-known in the literature that particle based ceramic material precursors may be structured and hardened, e.g. by spray forming particle based ceramics on a template (US2004/0149417), however, the as precursor particles have a macroscopic size, details smaller than the particle size may not be defined by this method. Alternatively micro or nanostructures may be defined by conventional lithographic methods (e.g. photolithography or electron beam lithography) or mechanical methods (e.g. embossing or nano-imprint lithography) in homogenous materials such as photoresists (see e.g. US2004/0182820, US2007/0257396, WO00/26157, WO2007/023413), however so far not demonstrated in materials capable of withstanding the conditions of industrial polymer shaping processes, where the mold is subject to both high pressure (e.g. 2000 atm) and high temperature (e.g. 300° C.) and high mechanical forces upon polymer injection in e.g. an injection molding process, and in particular have only been demonstrated on smooth substrates with a surface roughness much lower than the size of the intended nanostructures.

What we propose is to apply a layer of liquid ceramic material precursor, or in particular a silicon dioxide precursor such as Hydrogen Silsesquioxane, or a solution thereof with a thickness below 2 μm, or more preferably less than 3 μm, even more preferably less than 4 μm or most preferably less than 5 μm, directly on the surface of a conventional mold or mold insert for use in injection molding, blow molding, compression molding or calendering, structure it by a mechanical process such as embossing, curing it to a solid ceramic material and using it in a high pressure polymer shaping process where the mold temperature is kept under the solidification temperature of the polymer, such as injection molding, blow molding, compression molding or calendering. The novelty and inventive step of the invention is realized by the surprisingly high durability and surprisingly high adhesion strength of the solid ceramic material on the shaping surface of the mold. The further surprisingly easy way of nanostructuring or smoothing both planar and non-planar high surface roughness mold surfaces by deploying a ceramic material precursor or precursor solution as devised in this document also contribute to both the novelty and inventive step. A further surprising feature of the invention is the high replication quality during the polymer shaping process, due to the lower heat conductance and lower heat capacity of the deployed solid ceramic material, which also contributes to the inventive step. Furthermore it is highly surprising that the ceramic layer does not delaminate during use where the surface is brought in contact with e.g. 300° C. hot polymer melt, as the thermal expansion coefficient of metals, in particular steel or aluminum is much larger than the thermal expansion coefficient of the deployed ceramics, in particular silicon dioxide. This surprising effect is achieved through the use of a non-smooth metal substrate resulting in a larger interface area between the ceramic layer and the metal substrate and a plasma activation and thermal curing process allowing the two layers to be covalently bond together.

When using standard lithographic methods, fabrication of nanostructures normally requires a substrate with a lower surface roughness than the size of the desired nanostructures, and most often planar silicon wafers or glass wafers are used with a surface roughness below 5 nm. This causes a further problem when making molds comprising nanostructures, namely that the macroscopic geometry and the methods used for generating the macroscopic geometry, such as milling or electric discharge machining in general causes a high surface roughness above 5-10 μm. Abrasive polishing down to a 5-10 nm is possible but is very time consuming and prohibitively expensive, and has so far only been reported on planar geometries. The high surface roughness of the shaping surface may also be a problem in some applications, such as microscopy or cell culture, where the polymer parts are required to be smooth.

One further problem encountered in injection molding of nanostructures is incomplete replication of the nanostructures defined in the injection molding mold insert. This is largely due to the rapid cooling of the polymer upon injection, which is due to the high heat conductance and heat capacity of metals used as mold material compared to the lower heat conductance and lower heat capacity of the molten polymer being injected. Hence, an improved method and apparatus for producing a nanostructured polymer articles would be advantageous.

The present invention solves the four abovementioned problems with the restriction of applying nanostructures to arbitrary mold geometries, the limited durability of mold insert material, the incomplete replication of the nanostructures from mold to polymer due to rapid cooling upon injection and the requirements for extremely low surface roughness in the mold.

The present invention solves the problem of applying nanostructures to arbitrary mold geometries by deploying embossing combined with a liquid or ductile ceramic material precursor or precursor solution. The liquid or ductile precursor may be applied to the mold shaping surface, and structured or smoothened by embossing and cured into a solid ceramic material once in its desired geometry.

The present invention also solves the problem of limited durability of nanostructures in a mold by using solid ceramic materials, which are deterred less than metal nanostructures during usage, due to their superior (compared to metals) hardness and lack of re-crystallization.

The present invention also solves the surface roughness requirement within the mold by using a liquid or ductile ceramic material precursor or precursor solution, which is able to fill out the structures comprising the surface roughness of the mold, allowing the nanostructures to be formed on top of the filling of the surface roughness. In a special embodiment of the invention, no nanostructures are formed on top of the liquid or ductile ceramic material precursor or precursor solution, which to the contrary is made as smooth as possible, thereby giving an alternative to abrasive polishing where a low surface roughness mold or mold insert is required.

The present invention furthermore solves the problem of incomplete replication of nanostructures from the mold to the polymer during polymer shaping processes, such as injection molding, blow molding, compression molding or calendering, where the molten polymer only has limited time to replicate the nanostructures before the molten polymer solidifies, by increasing the time to solidification of the surface layer of the molten polymer by reducing the specific heat capacity and heat conductance of the nanostructured surface layer of the mold by using ceramic materials, thereby also increasing the contact temperature between melt and mold, resulting in a better replication of the nanostructured surface during the polymer shaping process, compared to a nickel mold made by the LIGA process.

### OBJECT OF THE INVENTION

It may be seen as an object of the present invention to provide an improved method for producing a polymer article that solves the above mentioned problems.

It may be seen as a further object of the present invention to provide an improved method for producing tools for use in polymer shaping applications comprising nanostructures article that solves the above mentioned problems.

It is an object of the present invention to present a technological solution, where durable micro or nanostructures may be applied directly to existing polymer shaping tools with a relative high surface roughness. It is a further object of the invention to be able to provide arbitrary micro or nanostructures directly on free-form curved polymer shaping tool surfaces. It is a further object to provide a thin thermal insulating (compared to metals) layer on the polymer shaping tool in order to increase the time to solidification of the polymer melt, providing a better replication of the micro or nanostructures. A further provided advantage is to make chemically modification in order to either increase the surface energy to the molten polymer, and/or to provide a surface modification improving the release of the solidified polymer possible. A further advantage provided is to increase the lifetime of the polymer shaping tool.

It is a further object of the present invention to provide an alternative to the prior art.

### SUMMARY OF THE INVENTION

The invention here presented regards the manufacturing of a nanostructured polymer replica by the use of a special nanostructured mold or tool, which is manufactured by the application of a thin layer of liquid ceramic material precursor solution, directly on the surface of a conventional high surface roughness mold or mold insert for use in polymer shaping processes, such as but not limited to injection molding, blow molding, compression molding, coining, deep drawing, extrusion, calendering, or other polymer shaping methods, allowing the solvent of the liquid ceramic precursor solution to evaporate in order to form a ductile film of ceramic material precursor, structuring the film of ductile ceramic material precursor by a mechanical process such as embossing, curing it to a film of structured solid ceramic material and using it in an industrial polymer shaping process, such as injection molding or calendering/extrusion. The novelty and inventive step of the invention is realized by the surprisingly high durability and surprisingly high adhesion strength of the solid ceramic material on the shaping surface of the mold. The further surprisingly easy way of micro or nanostructuring both planar and non-planar high surface roughness mold surfaces by deploying a ceramic material precursor solution as devised in the patent also contribute to both the novelty and inventive step. A further surprising feature of the invention is the high replication quality during the polymer shaping process, due to the lower heat conductance and lower heat capacity of the deployed solid ceramic material, which also contributes to the inventive step. A further surprising feature is the very high durability of the ceramic film, consisting of a silicon-oxide or glass like material, even when used in high pressure, high shear-stress processes such as injection molding where the injection pressure is up to 2000 bar with linear injection velocities up to 10 m/s.

The problems solved compared to state-of-the-art are that when using standard lithographic methods, fabrication of nanostructures requires a substrate with a lower surface roughness than the size of the desired nanostructures, and most often planar silicon wafers or glass wafers are used with a surface roughness below 5 nm. This causes a further problem when making molds comprising nanostructures, namely that the macroscopic geometry and the methods used for generating the macroscopic geometry, such as milling or electric discharge machining in general causes a high surface roughness above 5-10 μm. Abrasive polishing down to a 5-10 nm is possible but is very time consuming and prohibitively expensive.

A further problem is the fabrication of nanostructures on curved surfaces. State-of-the-art lithographic methods are adapted to planar surfaces, where the limitation is in particular the high focus required in the lithographic methods deployed and the derived low focal depth, demanding very planar substrates if micro or nanostructures are to be fabricated.

One further problem solved is an often encountered problem in injection molding of micro or nanostructures, namely incomplete replication of the micro or nanostructures defined in the injection molding mold insert. This is largely due to the rapid cooling of the polymer upon injection, which is due to the high heat conductance and heat capacity of metals used as mold material compared to the lower heat conductance and lower heat capacity of the molten polymer being injected.

One further problem solved which is encountered in state-of-the-art direct etching of the polymer shaping tool is the restriction in geometry due to the etching process, where only flat or half-spherical features may be manufactured by isotropic etching.

One further problem solved compared to state-of-the-art nanostructures are the durability of the nanostructures. By the LIGA-method, arbitrary nanostructures may be defined (in a planar geometry) in nickel, cobalt or copper. The durability of these materials is low (typically 10.000-100.000 replications) due to their intrinsic ductility and due to re-crystallization of the metals during use.

One further problem solved is the often cumbersome surface functionalization of nanostructures, where the functional film must be thin compared to the size of the nanostructures. PVD or CVD surface functionalization used in the industry today, are normally in the thickness range of 1000-3000 nm, thus not suited for nanostructures.

The present invention solves the six abovementioned problems with the restriction of applying (1) arbitrary nanostructures to (2) high surface roughness surfaces with (3) arbitrary non-planar mold geometries, (4) the limited durability of nanostructured mold insert material, (5) the incomplete replication of the nanostructures from mold to polymer due to rapid cooling upon injection and the (6) requirements for surface functionalization of the mold nanostructures.

The present invention solves the problem of applying micro or nanostructures to arbitrary high surface roughness mold geometries by deploying a liquid ceramic material precursor solution which may be used as a gap-filler to eliminate the initial surface roughness by coating the tool with said liquid ceramic precursor solution, providing a structurable film by evaporating the solvent of the liquid ceramic material precursor forming a low surface roughness ductile film of ceramic material precursor, structuring the said film of ductile ceramic material precursor by embossing the film with the desired nanostructure subsequently releasing the embossed nanostructure forming a structured film of ductile ceramic material precursor, curing the structure film of ductile ceramic material precursor to a structured film of hard ceramic material, optionally functionalizing it with a silane-based self assembled monolayer of a surface energy active substance, and finally using it for a polymer shaping process.

The invention relates to a method for producing a nanostructured polymer article comprising at least one nanostructured surface area said method comprising at least the following steps:
using an initial polymer shaping tool with a non-smooth surface as substrate for the subsequent steps. This will be referred to as the initial step.
applying a liquid ceramic material precursor solution onto at least one part of a shaping surface of a mold or mold insert used for shaping of thermoplastic polymers. This will be referred to as the coating step.
allowing the solvent of the liquid ceramic material precursor solution to evaporate, resulting in a thin film of ductile ceramic material precursor. This will be referred to as the evaporation step.
generating a nanostructure in said liquid or ductile ceramic material precursor or precursor solution by a structuring step where a master nanostructure is replicated into the said ceramic material precursor or said precursor solution forming the inverse master structure in the ceramic material precursor or precursor solution. This will be referred to as the structuring step.
curing the said nanostructured liquid or ductile ceramic precursor or precursor solution to a solid nanostructured ceramic material, which is both mechanically and thermally stable to the conditions of the subsequent polymer shaping step. This will be referred to as the curing step.
bringing the heated molten polymer in contact with the shaping surface maintained at a temperature lower than the solidification temperature of the said polymer, and allowing the molten polymer to solidify in order to form the said nanostructured polymer article. This will be referred to as the polymer shaping step.

These six steps will be referred to as the initial step, coating step, evaporation step, nanostructuring step, curing step and polymer shaping step, respectively.

In another aspect of the invention a smooth polymer article comprising a surface roughness less than preferably 250 nm, more preferably less than 100 nm, even more preferably less than 20 nm and most preferably less than 5 nm is produced by a method comprising at least the following steps:
using an initial polymer shaping tool with a non-smooth surface as substrate for the subsequent steps. This will be referred to as the initial step.
applying a liquid ceramic material precursor solution onto at least one part of a shaping surface of a mold or mold insert used for shaping of thermoplastic polymers. This will be referred to as the coating step.
allowing the solvent of the liquid ceramic material precursor solution to evaporate, resulting in a thin film of ductile ceramic material precursor. This will be referred to as the evaporation step.
smoothening the liquid or ductile ceramic material precursor or precursor solution by mechanical means such as but not limited to embossing, abrasive polishing, spinning or spontaneous smoothing by the means of gravity or surface tension, until a surface roughness of the ceramic material precursor or precursor solution of less than preferably 250 nm, more preferably less than 100 nm, even more preferably less than 20 nm and most preferably less than 5 nm is obtained. This will be referred to as the smoothening step.
curing the said liquid or ductile ceramic material precursor or precursor solution thereby transforming it into a smooth solid ceramic material which is mechanically and thermally stable to the conditions of the subsequent polymer shaping step. This will be referred to as the curing step.
bringing heated molten thermoplastic polymer in contact with the mold or mold insert, comprising the smooth shaping surface, maintained at a temperature lower than the solidification temperature of the said polymer, and allowing the molten polymer to solidify in order to form the said smooth polymer article. This will be referred to as the polymer replication step.

In particular the invention relates to a method for manufacturing nanostructured or smooth polymer parts in an arbitrary macroscopic geometry, including a non-planar geometry. The method is applied to a mold or mold insert, preferably consisting of a metal, and more preferably steel. The said mold or mold insert may have a surface roughness larger than 5 nm, preferably larger than 20 nm, more preferably more than 100 nm, even more preferably more than 300 nm, and most preferably more than 1 μm. Said mold or mold insert is coated with a layer of liquid or ductile ceramic material precursor or liquid or ductile ceramic material precursor solution, preferably a solution of a silsesquioxane, most preferably a solution of hydrogen silsesquioxane (HSQ). The mold or mold insert is coated by a layer of said liquid or ductile ceramic material precursor or precursor solution, preferably by using spray coating, spin coating or submersion coating. In case of a liquid or ductile ceramic material precursor solution, the solvent of the said liquid or ductile ceramic material precursor solution may optionally be allowed to at least partly evaporate in order to increase the viscosity of the said liquid or ductile ceramic material precursor, in order to obtain a suitable temperature dependent viscosity for making nanostructuring of said ceramic material precursor. This step will hereafter be referred to as the evaporation step. The said layer of liquid or ductile ceramic material precursor or precursor solution is structured or smoothened by a mechanical structuring or smoothening process, preferably an embossing process, which may optionally take place at an elevated temperature in order to melt or decrease the viscosity of the liquid or ductile ceramic material precursor or precursor solution. The structuring process is most preferably a room temperature embossing, hot embossing or nanoimprint lithography (NIL) process, transforming said layer of liquid or ductile ceramic material precursor or precursor solution into a nanostructured or smooth layer of liquid or ductile ceramic material precursor or precursor solution. The nanostructures brought into mechanical contact with the ceramic material precursor may have different geometries with characteristic length scales below 1 μm, including the special case of being a flat nanostructure, only comprised of the desired macroscopic geometry with a surface roughness less than 1 μm, preferably less than 250 nm, more preferably less than 100 nm, even more preferably less than 20 nm and most preferably less than 5 nm. After structuring or smoothening of the nanostructured or smooth layer of liquid or ductile ceramic material precursor or precursor solution, it is cured into a nanostructured or smooth layer of solid ceramic material, preferably by thermal curing, by plasma-curing or irradiation curing or a combination thereof. After the said curing, the said layer of solid nanostructured or smooth ceramic material may optionally be functionalized with a functional substance, preferably a fluor-carbon-alkane with a silane end group, by covalent coupling of the silane end group to the surface of the said solid nanostructured or smooth layer of solid ceramic material. This step will hereafter be referred to as the functionalization step.

After said curing or after said optional functionalization, the said mold or mold insert comprising said nanostructured or smooth solid ceramic material also optionally comprising said functional layer is used as shaping surface in a polymer shaping process, where molten thermoplastic polymer is brought into contact with said mold or mold insert comprising the layer of said nanostructured or smooth solid ceramic material, the process preferably being an injection molding process, blow molding process, compression molding process or a calendering process. During said polymer shaping process, the mold or mold insert is maintained at a temperature below the solidification temperature of the said polymer, and the polymer is allowed to cool below its solidification temperature and the desired nanostructured or smooth polymer part is removed from the said mold comprising the said layer of nanostructured or smooth solid ceramic material or said functional nanostructured or smooth solid ceramic material.

A nanostructured polymer article is herein defined as an article, e.g., a packaging material, a decorative surface, a toy, a container or part of a container or a part of a medical device or a functional part of a medical device where the nanostructure is intended to be able to change the surface properties of the material, non-limiting examples given; changing the hydrophilicity, molecular binding properties, sensing properties, biological properties or facilitating biological process, the optical, reflective or diffractive properties, its tactile properties or holographic properties. The nanostructured polymer article is formed by heating, shaping and cooling a polymer, e.g. a thermoplastic material by contact with a shaping surface maintained below the solidification temperature of the polymer. The shaping surface depends on the method of production of the polymer article. An example of shaping surface may be a mold insert when an injection molding process is used for the production of the polymer article. Another example of shaping surface may be a roller when the process used for the production of the polymer article is a calendering process. The shaping surface may have a plane or non-planar macroscopic form and may further comprise nanostructures on the shaping surface.

By mold or mold insert is meant any part of a mold which is part of the shaping surface of the polymer in the polymer shaping process. Non-limiting examples of this is a mold insert, the mold itself, a shim, an ejector pin an, injection valve or a calendering roller.

By a smooth surface is meant a surface with a surface roughness less than 100 nm, or preferably less than 50 nm, more preferably less than 25 nm, even more preferably less than 10 nm and most preferably less than 5 nm. Smooth surfaces are only characterized topologically by their macroscopic geometry and by their surface roughness. Many applications make use of smooth surfaces, non-limiting examples are surfaces of transparent materials used for microscopy, surfaces where low friction are required and surfaces that are to be highly reflective or shiny.

By a non-smooth surface is meant a surface with a surface roughness Rz of more than 500 nm, or preferably more than 300 nm, more preferably more than 100 nm, even more preferably more than 50 nm and most preferably more than 20 nm.

Non-smooth surfaces are not only characterized topologically by their macroscopic geometry and by their surface roughness, but also by their microtopography, often expressed through parameters such as but not limited to Ra, Rz, Rq, Sa, Sq or more complex parameters. In this disclosure Rz will be used for all surface roughness references unless otherwise stated, and Rz is the maximum deviation from the ideal, intended macroscopical geometry. Typical mechanical metal manufacturing technologies such as milling, electric discharge milling or cutting will result in a non-smooth surface.

By macroscopic is meant structures larger than 10 μm, and by nanostructures is meant structures with a characteristic length scale, such as width or length, defined as the directions parallel to the macroscopic surface below 1 μm. For a graphical representation of this, see FIG. 1.

By non-planar geometries is meant a shaping surface of the mold not being macroscopically planar, and hence capable of forming non-planar polymer parts.

By surface roughness is meant the vertical deviations of a real surface from its desired primary or macroscopic form. Large deviations defines a rough surface, low deviations define a smooth surface. Roughness can be measured through surface metrology measurements. Surface metrology measurements provide information on surface geometry. These measurements allow for understanding of how the surface is influenced by its production history, (e.g., manufacture, wear, fracture) and how it influences its behavior (e.g., adhesion, gloss, friction).

Surface primary form is herein referred as the over-all desired shape of a surface, in contrast with the undesired local or higher-spatial frequency variations in the surface dimensions.

Example on how to measure surface roughness are included in the document from the International Organization for Standardization ISO 25178 which collects all international standards relating to the analysis of 3D areal surface texture.

Roughness measurements can be achieved by contact techniques, e.g. by use of profilometers or atomic force microscope (AFM), or by non-contact techniques, e.g. optical instruments such as interferometers or confocal microscopes. Optical techniques have the advantages of being faster and not invasive, i.e. they do physically touch the surface which cannot be damaged.

Surface roughness values herein referred are intended as to be the values of the maximum peak to valley height of the profile along the surface primary form within a 10 μm sampling length. The values of maximum valley depth are defined as the maximum depth of the profile below the mean line along the surface primary form sampling length and the values of the maximum peak height are defined as the maximum height of the profile above the mean line along the surface primary form sampling length.

By liquid or ductile ceramic precursor material or liquid or ductile ceramic material precursor solution is meant a liquid or ductile material or solution of material that upon curing is capable of forming a solid, non-ductile ceramic material. As a way of example and not by way of limitation the said ceramic material precursors could be hydrogen silsesquioxane (HSQ) or methyl silsesquioxane (MSQ), capable of forming SiO₂ upon thermal curing at 600° C. for 1 hour.

By liquid or ductile is meant a material capable of being permanently, non-elastically deformed upon mechanical deformation, which comprises both low-viscosity liquids, such as water and organic solvents and high-viscosity and ductile substances capable of being plastically deformed, such as HSQ or MSQ.

By solid is meant a material not able to be plastically deformed at the conditions present in the polymer shaping process without fracturing the material or breaking covalent bonds in the material structure, non-limiting examples being SiO₂, glass, Si₃N₄, SiC, Al₂O₃, TiAlN, TiO₂, Ti₃N₂, B₂O₃, B₄C or BN.

By ceramic material is meant both crystalline and amorphous materials consisting of metals or metalloid covalently bound to non-metal and non-metalloid atoms. As a way of example and not by way of limitation the said ceramic material could contain the following materials or mixtures thereof: SiO₂, glass, Si₃N₄, SiC, Al₂O₃, TiAlN, TiO₂, Ti₃N₂, B₂O₃, B₄C or BN.

By coating is meant the process of applying a layer of the liquid or ductile ceramic precursor or precursor solution to the shaping surface of the said mold or mold insert. As a way of example and not by way of limitation the said coating method could comprise spin coating, spray coating or coating by submersion of the mold or mold insert into the said liquid or ductile ceramic material precursor or precursor solution.

By an embossing process is meant bringing a primary nanostructure into mechanical contact with the layer of liquid or ductile ceramic material precursor or precursor solution, whereby the inverse form of the primary nanostructure is formed in the layer of liquid or ductile ceramic material precursor or precursor solution. The structuring process may take place at an elevated temperature (hot embossing) in order to non-elastically or permanently deform the layer of liquid or ductile ceramic material precursor or precursor solution. The embossing process may incorporate the curing process, in such a way that the liquid or ductile ceramic material precursor or precursor solution is cured while the primary nanostructure is in contact with the liquid or ductile ceramic material precursor or precursor solution, a non-limiting example being the irradiation curing in step-and-flash NIL.

By curing is meant the process of transforming the liquid or ductile ceramic material precursor or liquid or ductile ceramic material precursor solution into the resulting solid ceramic material. This is typically done by covalent cross-linking of smaller molecular entities into a mesh structure, forming a solid ceramic substance. As a way of example and not by way of limitation the said curing method could be e.g. thermal curing where the ceramic precursor material is heated to a temperature where the cross linking takes place spontaneously, or the curing method could be a plasma curing where a plasma interacts chemically with the ceramic precursor material, thereby cross linking the ceramic precursor material, or the curing method could be an irradiation curing, where ionizing irradiation (e.g. UV exposure or electron irradiation) forms radicals in the ceramic material precursor or precursor solvent, causing the precursor to crosslink.

By functionalization is meant the process of covalently coupling a chemical substance to the surface of the layer of nanostructured or smooth solid ceramic material in order to obtain a given functionality of the surface. As a way of example and not by way of limitation the said functionalization may be to improve the slipping capabilities of the surface to the said polymer part, by reducing the demolding forces consisting mainly of thermal shrinkage stress and adhesive forces, thereby making demolding easier, or it may be a surface energy increasing substance, improving the replication of the nanostructures during shaping of the said polymer part. A non-limiting example of the first is a self assembled monolayer of fluor-carbon-alkanes, covalently coupled to the surface of the solid ceramic material by a silane group, a non-limiting examples of the second is the coupling of Hexamethyldisilazane (HMDS) to the surface of the solid ceramic material.

By polymer shaping process is meant the mechanical process of shaping a molten thermoplastic polymer into a solid polymer part by bringing the molten polymer into contact with the mold or mold insert comprising the shaping surface, where the average temperature of said mold or mold insert comprising the shaping surface is kept below the solidification temperature of said thermoplastic polymer. The process may be an injection molding process, a compression molding process or a calendering process. Non-limiting examples of thermoplastic polymer that may be used are acrylonitrile butadiene styrene (ABS), acrylic, celluloid, cellulose acetate, Ethylene-Vinyl Acetate (EVA), Ethylene vinyl alcohol (EVAL), Fluoroplastics, gelatin, Liquid Crystal Polymer (LCP), cyclic oleofin copolymer (COC), polyacetal, polyacrylate, polyacrylonitrile, polyamide, polyamide-imide (PAI), polyaryletherketone, polybutadiene, polybutylene, polybutylene therephthalate, polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, polyethylene (PE), polyetheretherketone (PEEK), polyetherimide (PEI), polyethersulfone (PES), Polyethylenechlorinates (PEC), polyimide (PI), polylactic acid (PLA), Polymethylpentene (PMP), polyphenylene oxide (PPO), polyphenylene sulfide (PPS), polyphthalamide (PPA), polypropylene (PP), polystyrene (PS), polysulfone (PSU), polyurethane (PU), polyvinyl acetate (PVA), polyvinyl chloride (PVC), polyvinylidene chloride (PVDC) and styrene-acrylonitrile (SAN), a polymer matrix substance for a medical drug, or mixes or copolymers thereof.

In some embodiments the mold or mold insert comprises at least part of an injection molding, compression molding or blow molding mold, non-limiting examples being the mold itself, a mold insert, a shim, an ejector pin or an injection valve.

In some embodiments the mold or mold insert comprises at least part of a calendering roller.

In some embodiments the mold or mold insert comprises a surface roughness larger than 20 nm, preferably larger than 100 nm, more preferably more than 250 nm, even more preferably more than 1 μm, and most preferably more than 3 μm before the coating step.

In some embodiments the coating step comprises a spin coating process, where the mold or mold insert is placed on a rotational stage. A volume of the liquid or ductile ceramic material precursor or precursor solution is placed on the desired shaping surface of the mold or mold insert. Rotation of the mold or mold insert ensures that the liquid or ductile ceramic material precursor or precursor solution is evenly distributed on the desired shaping surface.

In some embodiments the coating step comprises a spray coating process, where the liquid ceramic material precursor or precursor solution is forced through small openings in order to generate small droplets of liquid ceramic material precursor or precursor solution. These droplets are sprayed on the desired mold or mold insert surface to generate an evenly distributed layer of liquid ceramic material precursor or precursor solution on the desired surface.

In some embodiments the coating step comprises a submersion coating, where the mold or mold insert is submerged in the liquid ceramic material precursor or precursor solution. Subsequently the mold or mold insert is removed from the liquid ceramic material precursor or precursor solution where excess liquid ceramic material precursor or precursor solution is removed by mechanical means non limiting examples given: gravity, mechanical scraping, blowing with compressed gas or spinning of the mold or mold insert.

In some embodiments the evaporation step comprises placing the mold or mold insert comprising the layer of liquid or ductile ceramic material precursor solution in an oven or on a heat plate to accelerate evaporation, or place the mold or mold insert comprising the layer of liquid or ductile ceramic material precursor solution in a vacuum chamber to accelerate evaporation, or a combination thereof, e.g. a vacuum oven.

In some embodiments the evaporation step comprises placing the mold or mold insert comprising the layer of liquid or ductile ceramic material precursor solution at ambient temperature and pressure for a given time.

In some embodiments where a smooth surface is desired, the primary nanostructure comprises the desired macroscopic geometry with a surface roughness less than 1 μm, preferably less than 250 nm, more preferably less than 100 nm, even more preferably less than 20 nm and most preferably less than 5 nm.

In some embodiments the primary nanostructure comprises nanostructures made by lithographic or holographic means with a characteristic length scale of less than 1 μm.

In some embodiments the nanostructuring step comprises an embossing process, where a primary nanostructure is brought in physical contact with the layer of liquid or ductile ceramic material precursor or precursor solution and pressed into the layer of liquid or ductile ceramic material precursor or precursor solution, thereby generating an inverse pattern of the primary nanostructure in the layer of liquid or ductile ceramic material precursor or precursor solution.

In some embodiments the nanostructuring step comprises a hot embossing process where a heated primary nanostructure is brought in physical contact with the heated layer of liquid or ductile ceramic material precursor or precursor solution and pressed into the layer of liquid or ductile ceramic material precursor or precursor solution, thereby generating an inverse pattern of the primary nanostructure in the layer of liquid or ductile ceramic material precursor or precursor solution. After generation of the nanostructure, the primary nanostructure, the layer of layer of liquid or ductile ceramic material precursor or precursor solution and the mold or mold insert is allowed to cool to a lower temperature in order to make the geometry of the nanostructured layer of liquid or ductile ceramic material precursor or precursor solution more mechanically stable by increasing the temperature dependent viscosity, thereby not deterring it during removal of the primary nanostructure.

In some embodiments the nanostructuring step comprises a step-and-repeat or step-and-flash nano imprint lithography (NIL) process where a primary nanostructure is brought in physical contact with the coated layer of liquid or ductile ceramic material precursor or precursor solution and pressed into the layer of liquid or ductile ceramic material precursor or precursor solution, thereby generating an inverse pattern of the primary nanostructure in the layer of liquid or ductile ceramic material precursor or precursor solution. This process is repeated a number of times on different areas on the layer of liquid or ductile ceramic material precursor or precursor solution. A curing step may be incorporated between each repetition before removal of the primary nanostructure in order to transform the liquid or ductile ceramic material precursor or precursor solution into a solid ceramic material, the curing step preferably being an irradiation curing step.

In some embodiments, the structuring step is a smoothening process, where the surface of the liquid or ductile ceramic material precursor or precursor solution is smoothened. Non-limiting examples of such processes are embossing with a primary structure with a smooth surface, spinning of the mold or mold insert comprising the liquid or ductile ceramic material precursor or precursor solution, heating of the liquid or ductile ceramic material precursor or precursor solution in order to make surface tension smoothening the surface, or mechanical polishing of the liquid or ductile ceramic material precursor or precursor solution.

In some embodiments the curing step comprises a thermal curing process where the layer of nanostructured or smooth liquid or ductile ceramic material precursor or precursor solution is heated to a curing temperature for a given period of time, thereby transforming the layer of nanostructured or smooth liquid or ductile ceramic material precursor or precursor solution into a solid nanostructured or smooth ceramic material by cross-linking of the ceramic material precursor and/or ceramic material precursor solvent.

In some embodiments the curing step comprises a plasma curing process where the layer of nanostructured or smooth liquid or ductile ceramic material precursor or precursor solution is subjected to a plasma, the plasma inducing cross-linking of the ceramic material precursor and/or ceramic material precursor solvent, thereby transforming the layer of the liquid or ductile ceramic material precursor and/or ceramic material precursor solvent into a solid ceramic material.

In some embodiments the curing step comprises an irradiation curing process, where the layer of liquid or ductile ceramic material precursor and/or ceramic material precursor solvent is irradiated by ionizing radiation, non-limiting examples being electron beam radiation, UV-radiation, gamma-radiation or x-ray radiation. The ionizing radiation generates free radicals in the ceramic material precursor and/or ceramic material precursor solvent, thereby cross-linking the liquid or ductile ceramic material precursor and/or ceramic material precursor solvent to form a solid ceramic material.

In some embodiments the functionalization step comprises a vacuum process where a reactive gas at low pressure is brought in contact with the mold or mold insert comprising the layer of solid nanostructured or smooth ceramic material, the process preferably being a molecular vapor deposition (MVD) process. The reactive gas is preferably Hexamethyldisiloxane or Hexamethyldisilazane (HMDS), or preferably a silane with a fluoro-carbon-alkane end group, more preferably perfluorodecyltrichlorosilane (FDTS) or perfluorooctyltrichlorosilane FOTS.

In some embodiments the functionalization step comprises a wet chemical process where the mold or mold insert comprising the layer of solid nanostructured or smooth ceramic material is brought in contact with a reactive liquid substance or a liquid solution of a reactive substance, the reactive substance preferably being a silane with a functional end group, more preferably perfluorodecyltrichlorosilane (FDTS) or perfluorooctyltrichlorosilane FOTS.

In some embodiments the polymer shaping step comprises an injection molding or gas assisted injection molding (blow molding) process. Injection molding is performed by heating a suitable thermoplastic polymer until molten, injecting the molten polymer (and gas in the case of blow molding) into a mold, allowing the polymer to cool and harden, and removing the molded article from the mold. This process may be automated and therefore used to produce a rapid succession of identical articles. The mold used may have means for cooling, in order to increase the speed of solidification of the polymer. A removable shaping surface, e.g. an insert may be incorporated into the mold, and this insert may bear surface nanostructures and/or macroscopic shape that are transferred to the polymer article during the molding process. Alternatively, such structure may be present on the mold so that the mold in itself may be the shaping surface. Such an embodiment may make use of an injection molding mold or mold insert that is made of metal, preferably steel comprising a nanostructured or smooth surface made of a solid ceramic material.

In some embodiments the polymer shaping step comprises a compression molding process. Compression molding is performed by heating a suitable polymer until molten in an open mold or mold cavity, closing the mold or mold cavity, thereby compressing the polymer and forcing it to fill all parts of the mold or mold cavity, allowing the polymer to cool and harden, and removing the molded article from the mold. This process may be automated and therefore used to produce a rapid succession of identical articles. The mold used may have means for cooling, in order to increase the speed of hardening of the polymer. A removable shaping surface, e.g. an insert may be incorporated into the mold, and this insert may bear surface nanostructures and/or macroscopic shape that are transferred to the polymer article during the molding process. Alternatively, such structure may be present on the mold so that the mold in itself may be the shaping surface. Such an embodiment may make use of a compression molding mold or mold insert that is made of metal, preferably steel comprising a nanostructured or smooth surface made of a solid ceramic material.

In some other embodiments the polymer shaping step comprises a calendering process. Calendering is a process used to manufacture polymer sheeting. A suitable polymer in pellet form is heated and forced through a series of heated rollers until the polymer sheet reaches the desired dimensions. The sheeting is then passed through cooling rollers in order to cool and set the polymer. Frequently, texture is applied to the polymer sheet during the process, or a strip of fabric is pressed into the back of the polymer sheet to fuse the two together. The calendering process may be used in combination with extrusion—the extruded polymer form may be passed through the heated rollers of the calender as above until the required dimensions are obtained, and then passed over cooling rollers to set the form of the polymer. A calendering roller made of metal is temporarily submerged in the liquid ceramic material precursor solution, where after the roller is spun to ensure the desired precursor film thickness. The roller coated with the precursor film is structured using step-and-repeat NIL. Thereafter the roller is cured by a combination of a plasma and elevated temperature. The cured roller is then functionalized with a fluor-carbon alkane with a reactive end group improving the release properties of the roller. The roller is then used for calendering, whereby the nanostructures defined in the nanostructured layer of solid ceramic material is replicated.

All of the features described may be used in combination so far as they are not incompatible therewith. Thus, spin coating, spray coating, submersion coating, embossing, hot embossing, nanoimprint lithography, smoothening, thermal curing, plasma curing, irradiation curing, vacuum functionalization, wet functionalization, injection molding, blow molding, compression molding and calendering may be used in any combination or combined, e.g. part of the process may be carried by injection molding and part by calendering.

### DETAILED DESCRIPTION OF THE INVENTION

The present invention is a method for applying micro or nanostructures to a conventional polymer shaping tool. It consists of 6 mandatory and 1 optional step: (1) An initial conventional polymer shaping tool with a non-smooth surface, (2) coating of the conventional polymer shaping tool with a liquid ceramic material precursor solution, (3) evaporation of solution solvent to form a ductile film, (4) Structuring of the ductile film by a mechanical embossing process, (5) curing of the structured ductile film of ceramic material precursor to a structured film of hard ceramic material, and (6) optionally functionalizing the structured film of hard ceramic material with a self assembled monolayer of a silane with a functional end-group, and (7) a polymer shaping step where the tool is used for making a nanostructured polymer replica by an industrial polymer shaping process. (1) is referred to as the initial step, (2) is referred to as the coating step, (3) is referred to as the evaporation step, (4) is referred to as the structuring step, (5) is referred to as the curing step, (6) is referred to as the (optional) functionalization step and (7) is referred to as the polymer shaping step.

Each step will now be described in detail.

Conventional polymer shaping tools are made into their desired geometry by mechanical machining of hard materials, most often steel. These mechanical machining processes typically results in a surface roughness (as defined in FIG. 1) in the range from 10 μm to 100 μm. For applications requiring good optical transparency of the polymer, polishing of the tool is done, typically to obtain a surface roughness of 1-3 μm. In extreme cases the tool may be polished further to obtain surface roughnesses as low as 5-10 nm, however this is very time consuming and expensive, especially if the surface is not planar (where specialized machinery exists, somewhat lowering the cost of polishing). If a method for micro or nanostructuring free-form polymer shaping tools shall have commercial relevance it is necessary that it is applicable to tools with a surface roughness at least above 100 nm-1 μm, and more preferably in the range 1-10 μm and most preferably in the range of 10-100 μm.

The coating of a free-form surface with a high surface roughness by a liquid ceramic material precursor solution may be done by a number of methods, such as spray coating, where small droplets of the solution is formed and sprayed onto the desired tool surface, submersion coating, where the tool is submerged in the solution and subsequently removed and dried by pressurized gas, whereby the solution will form a thin film on the surface of the tool, or spin coating where a drop of solution is placed on the surface of the tool, which is subsequently spun in order to make the drop of solution be evenly distributed over the surface of the tool by the centrifugal forces obtained by the spinning. The thickness of the film may be varied by the amount of solution applied to the tool surface, which could be controlled by parameters such as but not limited to droplet size, droplet density (droplets pr volume), spray time, air pressure, spin velocity, spin time, viscosity of the solution, and the ratio of dissolved ceramic material precursor in the solvent. A preferred liquid ceramic material precursor solution is Hydrogen Silsesquioxane (HSQ) or Methyl Silsesquioxane (MSQ) dissolved in an organic solvent such as but not limited to Methyl isobutyl ketone (MIBK) or volatile methyl siloxanes (VMS). These solutions are available as commercial products, e.g. Floatable Oxide (FOx) 12-17 or FOx-22-25 from Dow Corning.

Evaporation of the solvent happens spontaneously at room temperature, leaving a thin ductile film of HSQ or MSQ on the surface of the polymer shaping tool. The resulting film thickness after evaporation (defined as in FIG. 5) will be dependent on the thickness of the liquid film and the concentration of ceramic material precursor in the liquid solvent. The thickness is defined as the thickness of the layer of ceramic material precursor where no part of the initial tool is present, thus disregarding the ceramic material precursor used for gap-filling in the surface roughness of the initial tool.

Structuring of the ductile film of ceramic material precursor are done by embossing a master structure into the ductile film, thus making a plastic deformation of this film, leaving a topographical structure in the ductile film after removal of the master structure. The master structure may for example consist of structures defined in metals, such as nickel made by the LIGA process, polymer foils containing topographical structures, resist-on-silicon structures made by lithographic methods, Polydimethylsiloxane (PDMS) stamps made by casting. The embossing may be performed by either using hydrostatic pressure in case of a flexible master structure to ensure an even distribution of the embossing force over the whole tool area, or it may be done by pressing a conform non-flexible stamp into the surface of the ductile film. The temperature may be elevated, or the embossing may be performed at room temperature. Typical pressures used in the embossing ranges from 5 to 500 bars, depending on the temperature, the ductility of the film and the master structure.

Curing of the structured ductile film of ceramic material precursor preferably takes place by heating the tool to a certain transition temperature where the ductile ceramic precursor reacts, thereby forming a solid, hard ceramic material in the same topography as the ductile film. Another method to induce this reaction is to plasma-treat the surface or expose the surface to ionizing radiation while the surface is kept sufficiently cold to prevent melting of the ductile film prior to thermal curing, ensuring that a layer on the surface has already reacted, thus not being able to melt and reform during the thermal curing. Curing may be done after release of the master structure, or be done before release of the master structure as in step-and-repeat nano-imprint lithography. If curing is done before removal of the master structure, there is no requirement for the ceramic material precursor to obtain a ductile (non-liquid) state, although too much excess non-ceramic forming solvent may cause the resulting film to be porous and hence less durable.

Functionalization of the surface may be done by covalently binding silane groups to the surface of the structured ceramic material. When using the preferred ceramic material precursors, HSQ or MSQ or a mixture thereof, the obtained hard ceramic material will primarily consist of SiO₂. The surface will feature Si—OH groups, to which e.g. a silane-tri-chloride (R—Si(Cl)₃) may covalently couple in order to generate a self assembled monolayer, whose functionality depends on the group R. In case of R being a fluor-carbon-alkane, a non-stiction surface functionality is obtained, easing the de-molding properties of the tool, and in case of a hydrogen-carbon-alkane, an increase in surface energy towards the molten polymer to be shaped is obtained, improving the polymer replication of tool structures, in particular nanometer sized structures.

In a special embodiment of the invention, a flat structure is formed on the ductile film of ceramic material precursor, which makes the initial high surface roughness tool smooth with a surface roughness as low as 2 nm, thereby giving an alternative to abrasive polishing where a low surface roughness mold or mold insert is required.

The invention relates to a method for producing a topographically structured shaping tool for the shaping of polymers, comprising at least one micro or nanostructured surface area, said method comprising at least the following steps:
applying a liquid ceramic material precursor solution onto at least one part of a shaping tool with a surface roughness of at least 1000 nanometers.
allowing at least part of the solvent of the liquid ceramic precursor solution to evaporate, thereby forming a ductile, thin film of ceramic material precursor with a thickness of preferably less than 2 μm, more preferably less than 3 μm, even more preferably less than 4 μm and most preferably less than 5 μm.
generating a micro or nanostructure in said ductile ceramic material precursor by a structuring step where a primary topographical master structure is replicated by physical contact forming the inverse of the master structure in the said film of ductile ceramic material precursor
curing the said film of structured ductile precursor, thereby transforming it into a structured solid ceramic material.

The invention furthermore relates to a method where the macroscopic geometry of the said tool shaping surface comprising is non-planar, where the said polymer shaping tool is made of hardened steel, where the said application of the liquid ceramic material precursor solution is done by spray coating or spin coating or by at least partly submerging the tool or tool insert into the said ceramic material precursor solution, subsequently removing the tool or tool insert from said ceramic material precursor solution, subsequently removing excess ceramic material precursor solution by mechanical means, such as but not limited to, gravity, mechanical scraping, rotation of the tool or tool insert or blow drying with a compressed gas.

Furthermore the invention relates to a method where the structuring step is an embossing process, which takes place at ambient temperature or takes place at an elevated temperature below the curing temperature of the ceramic material precursor, and where the embossing force is applied on a flexible master structure by hydrostatic pressure or by direct application of force to a non-flexible master structure, and where the structuring step comprises embossing of the master structure is repeated more than once.

Furthermore the invention relates to a method where the curing is a thermal curing, a plasma curing or an ionizing radiation curing or a combination thereof.

In particular the invention relates to a method where the liquid ceramic precursor primarily consisting of hydrogen silsesquioxane (HSQ), methyl silsesquioxane (MSQ) or a mixture thereof and the solvent consisting of a volatile organic solvent, where the curing step is a thermal curing at a temperature between 500° C. and 700° C.

Furthermore the invention relates to a method where the film of ceramic material precursor is cured by heat or ionizing radiation before release of the master structure, as in step and repeat NIL, where the ceramic material precursor is cured by e.g. UV-radiation. In this aspect, the film of ceramic material precursor does not need to have obtained a ductile (non-liquid) state, as the master structure will ensure that the topography of the film of the ceramic material precursor is generated successfully and not allowed deform plastically before the curing of the ceramic material precursor.

The invention also relates to a method where the cured tool or tool insert comprising a layer of structured solid ceramic material is coated with a chemically functional substance such as, but not limited to, perfluorodecyltrichlorosilane (FDTS), perfluorooctyltrichlorosilane FOTS, or Hexamethyldisilazane or Hexamethyldisiloxane (HMDS) covalently bound to the solid structured ceramic material.

The invention also relates to the application of said structured polymer shaping tool for use in polymer shaping processes such as, but not limited to injection molding, gas assisted injection molding, blow molding, compression molding, calendering, extrusion, deep drawing or coining, and the structured polymer replica made by any of these polymer shaping methods.

In particular the invention relates to a method for manufacturing nanostructured polymer shaping tools in an arbitrary macroscopic geometry, including a non-planar geometry. The method is applied to a mold or mold insert, preferably consisting of a metal, and more preferably steel. The said mold or mold insert may have a surface roughness larger than 100 nm, preferably larger than 500 nm, more preferably more than 1000 nm, even more preferably more than 3000 nm, and most preferably more than 10 μm. Said mold or mold insert is coated with a thin layer of liquid ceramic material precursor solution, preferably a solution of a silsesquioxane, most preferably a solution of hydrogen silsesquioxane (HSQ). The thickness of the film (defined as the HSQ material on top of the mold roughness, see FIG. 2) is preferably lower than 50 μm, more preferably lower than 25 μm, even more preferably lower than 10 μm and most preferably lower than 5 μm in order to obtain the most durable surface of the polymer shaping tool. The mold or mold insert is coated by said liquid ceramic material precursor solution, preferably by using spray coating, spin coating or submersion coating. The solvent of the said liquid ceramic material precursor solution are allowed to at least partly evaporate in order to increase the viscosity of the said liquid ceramic material precursor solution, in order to obtain a ductile film of ceramic material precursor, with a suitable (temperature dependent) hardness for making the nanostructuring step of said film of ductile ceramic material precursor possible. The said film of ductile ceramic material precursor is structured by a mechanical structuring process, preferably an embossing process, which may optionally take place at an elevated temperature in order to melt or decrease the hardness of the ductile film of ceramic material precursor. The structuring process is most preferably a room temperature embossing, hot embossing or nanoimprint lithography (NIL) process, transforming said film of ductile ceramic material precursor into a topographically structured film of ductile ceramic material precursor. The micro or nanostructures brought into mechanical contact with the ductile film of ceramic material precursor may have different geometries with characteristic length scales perpendicular to the surface below the film thickness. After structuring of the ductile film of ceramic material precursor, it is cured into a structured film of solid ceramic material, preferably by thermal curing, by plasma-curing or irradiation curing or a combination thereof. After the said curing, the said film of solid structured ceramic material may optionally be functionalized with a functional substance, preferably a fluor-carbon-alkane with a silane end group, by covalent coupling of the silane end group to the surface of the said solid structured film of solid ceramic material. This step will hereafter be referred to as the functionalization step.

After said curing or after said optional functionalization, the said tool or tool insert comprising said structured film of solid ceramic material also optionally comprising said functional layer is used as shaping surface in a polymer shaping process, the process preferably being an injection molding process, blow molding process, compression molding process, calendering process, extrusion process, deep drawing process or a coining process.

An example of a shaping surface may be a mold insert when an injection molding process is used for the production of the polymer article. Another example of shaping surface may be a roller when the process used for the production of the polymer article is a calendering or extrusion process. The shaping surface of the polymer shaping tool have a plane or non-planar macroscopic form and further comprises the said structured film of hard ceramic material on the shaping surface of the tool.

By tool or mold or tool insert or mold insert is meant any part of a mold which is part of the shaping surface of the polymer in the polymer shaping process. Non-limiting examples of this is a mold insert, the mold itself, a shim, an ejector pin an, injection valve or a calendering or extrusion roller.

By macroscopic is meant the geometry of the initial tool before coating with the liquid solution of ceramic material precursor, and by micro or nanostructures is meant structures with a characteristic height lower than the thickness of the said film of ductile ceramic material precursor.

By non-planar geometries is meant a shaping surface of the mold not being macroscopically planar, and hence capable of shaping non-planar polymer parts, or capable of being used as a roller in a roll-to-roll process.

By surface roughness is meant the vertical deviations of a real surface from its desired primary or macroscopic form. Large deviations defines a rough surface, low deviations define a smooth surface. Roughness can be measured through surface metrology measurements. Surface metrology measurements provide information on surface geometry. These measurements allow for understanding of how the surface is influenced by its production history, (e.g., manufacture, wear, fracture) and how it influences its behavior (e.g., adhesion, gloss, friction).

Surface primary form is herein referred as the over-all desired shape of a surface, in contrast with the undesired local or higher-spatial frequency variations in the surface dimensions.

Example on how to measure surface roughness are included in the document from the International Organization for Standardization ISO 25178 which collects all international standards relating to the analysis of 3D areal surface texture.

Roughness measurements can be achieved by contact techniques, e.g. by use of profilometers or atomic force microscope (AFM), or by non-contact techniques, e.g. optical instruments such as interferometers or confocal microscopes. Optical techniques have the advantages of being faster and not invasive, i.e. they do physically touch the surface which cannot be damaged.

Surface roughness values herein referred are intended as to be the values of the maximum peak to valley height of the profile along the surface primary form within a 10 μm sampling length. The values of maximum valley depth are defined as the maximum depth of the profile below the mean line along the surface primary form sampling length and the values of the maximum peak height are defined as the maximum height of the profile above the mean line along the surface primary form sampling length.

By liquid ceramic precursor material solution is meant a liquid solution of material that upon curing is capable of forming a solid, non-ductile ceramic material. As a way of example and not by way of limitation the said liquid solution of ceramic material precursors could be hydrogen silsesquioxane (HSQ) in Methyl isobutyl ketone (MIBK) or methyl silsesquioxane (MSQ) in Methyl isobutyl ketone (MIBK), capable of forming a ductile film of HSQ or MSQ by evaporation of the solvent (MIBK). HSQ and MSQ will cross-link into a solid material, primarily consisting of SiO₂ upon thermal curing at 600° C. for 1 hour.

By thin film is meant a film with a thickness less than 2 μm, preferably less than 3 μm, more preferably less than 4 μm and most preferably less than 5 μm.

By ductile is meant a material capable of being permanently, non-elastically deformed upon mechanical deformation without breaking, thereby obtaining a new permanent geometry after release of force or pressure responsible for the mechanical deformation. In particular we here mean a film that does not significantly change geometry spontaneously after releasing the master structure. A test for this is to see if a change in film thickness by more than 10% by flow induced by gravitational forces parallel to the surface within a time span of 1 hour occurs.

By solid is meant a material not able to be plastically deformed at the conditions present in the polymer shaping process without fracturing the material or breaking covalent bonds in the material structure, non-limiting examples being SiO₂, glass, Si₃N₄, SiC, Al₂O₃, TiAlN, TiO₂, Ti₃N₂, B₂O₃, B₄C or BN.

By ceramic material is meant both crystalline and amorphous materials consisting of metals or metalloid covalently bound to non-metal and non-metalloid atoms. As a way of example and not by way of limitation the said ceramic material could contain the following materials or mixtures thereof: SiO₂, glass, Si₃N₄, SiC, Al₂O₃, TiAlN, TiO₂, Ti₃N₂, B₂O₃, B₄C or BN.

By coating is meant the process of applying a layer of the liquid ceramic precursor solution to the shaping surface of the said mold or mold insert. As a way of example and not by way of limitation the said coating method could comprise spin coating, spray coating or coating by submersion of the mold or mold insert into the said liquid ceramic material precursor solution.

By a mechanical structuring process is meant bringing a primary structure into mechanical contact with the said film of ductile ceramic material precursor, whereby the inverse form of the primary structure is formed in the said film of ductile ceramic material precursor by non-elastically or permanently deforming the film of ductile ceramic material precursor. The structuring process may optionally take place at an elevated temperature (hot embossing) in order reduce the hardness of the film of ductile ceramic material precursor. The embossing process may optionally incorporate the curing process, in such a way that the ductile ceramic material precursor is cured while the primary nanostructure is in contact with the ductile ceramic material precursor, a non-limiting example being the UV-irradiation curing in step-and-flash Nano Imprint Lithography (NIL).

By curing is meant the process of transforming the ductile ceramic material precursor into the corresponding solid ceramic material. This is typically done by covalent cross-linking of smaller molecular entities into a mesh or grid structure, forming a solid ceramic substance. As a way of example and not by way of limitation the said curing method could be e.g. thermal curing where the ceramic precursor material is heated to a temperature where the cross linking takes place spontaneously, or the curing method could be a plasma curing where a plasma interacts chemically with the ceramic precursor material, thereby cross linking the ceramic precursor material, or the curing method could be an irradiation curing, where ionizing irradiation (e.g. UV exposure or electron irradiation) forms radicals in the ceramic material precursor or precursor solvent, causing the precursor to crosslink.

By functionalization is meant the process of covalently coupling a chemical substance to the surface of the layer of structured solid ceramic material in order to obtain a given functionality of the surface. As a way of example and not by way of limitation the said functionalization may be to improve the slipping capabilities of the surface to the said polymer part, by reducing the demolding forces consisting mainly of thermal shrinkage stress and adhesive forces, thereby making demolding easier, or it may be a surface energy increasing substance, improving the replication of the nanostructures during shaping of the said polymer part. A non-limiting example of the first is a self assembled monolayer of fluor-carbon-alkanes, covalently coupled to the surface of the solid ceramic material by a silane group, a non-limiting examples of the second is the coupling of Hexamethyldisilazane (HMDS) to the surface of the solid ceramic material.

By polymer shaping process is meant the mechanical process of shaping a molten or ductile polymer into a surface structured polymer part by bringing polymer into contact with the mold or mold insert comprising the shaping surface, at a temperature or at a pressure where the polymer is ductile, an hence possible to structure. Non-limiting examples of such processes are an injection molding process, a compression molding process, a calendering process, an extrusion process or a coining process. Non-limiting examples of polymers that may be used are acrylonitrile butadiene styrene (ABS), acrylic, celluloid, cellulose acetate, Ethylene-Vinyl Acetate (EVA), Ethylene vinyl alcohol (EVAL), Fluoroplastics, gelatin, Liquid Crystal Polymer (LCP), cyclic oleofin copolymer (COC), polyacetal, polyacrylate, polyacrylonitrile, polyamide, polyamide-imide (PAI), polyaryletherketone, polybutadiene, polybutylene, polybutylene therephthalate, polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, polyethylene (PE), polyetheretherketone (PEEK), polyetherimide (PEI), polyethersulfone (PES), Polyethylenechlorinates (PEC), polyimide (PI), polylactic acid (PLA), Polymethylpentene (PMP), polyphenylene oxide (PPO), polyphenylene sulfide (PPS), polyphthalamide (PPA), polypropylene (PP), polystyrene (PS), polysulfone (PSU), polyurethane (PU), polyvinyl acetate (PVA), polyvinyl chloride (PVC), polyvinylidene chloride (PVDC) and styrene-acrylonitrile (SAN), a polymer matrix substance for a medical drug, or mixes or copolymers thereof.

In some embodiments the tool or tool insert comprises at least part of an injection molding, compression molding or blow molding mold, non-limiting examples being the mold itself, a mold insert, a shim, an ejector pin or an injection valve.

In some embodiments the tool or tool insert comprises at least part of a calendering or extrusion roller.

In some embodiments the tool comprises of an extrusion tool.

In some embodiments the tool or tool insert comprises a surface roughness larger than 100 nm, preferably larger than 500 nm, more preferably more than 1000 nm, even more preferably more than 3000 nm, and most preferably more than 10 μm before the coating step.

In some embodiments the coating step comprises a spin coating process, where the tool or tool insert is placed on a rotational stage. A volume of the liquid ceramic material precursor solution is placed on the desired shaping surface of the tool or tool insert. Rotation of the tool or tool insert ensures that the ceramic material precursor solution is evenly distributed on the desired shaping surface.

In some embodiments the coating step comprises a spray coating process, where the liquid ceramic material precursor solution is forced through small openings in order to generate small droplets of liquid ceramic material precursor solution.

These droplets are sprayed on the desired tool or tool insert surface to generate an evenly distributed layer of liquid ceramic material precursor solution on the desired surface.

In some embodiments the coating step comprises a submersion coating, where the tool or tool insert is submerged in the liquid ceramic material precursor solution. Subsequently the tool or tool insert is removed from the liquid ceramic material precursor solution where excess liquid ceramic material precursor solution is removed by mechanical means, non-limiting examples given: gravity, mechanical scraping, blowing with compressed gas or spinning of the tool or tool insert.

In some embodiments the evaporation step comprises placing the tool or tool insert comprising the layer of liquid ceramic material precursor solution in an oven or on a heat plate to accelerate evaporation, or place the tool or tool insert comprising the layer of liquid ceramic material precursor solution in a vacuum chamber to accelerate evaporation, or a combination thereof, e.g. a vacuum oven.

In some embodiments the evaporation step comprises placing the tool or tool insert comprising the layer of liquid ceramic material precursor solution at ambient temperature and pressure for a given time.

In some embodiments the coating and evaporation step is one step, such as in spin coating, where the liquid is first evenly distributed, and secondly the solvent is allowed to evaporate.

In some embodiments the primary structure comprises micro or nanostructures made by lithographic or holographic means with a characteristic length scale of less than 10 μm, or more preferably less than 3 μm, even more preferably less than 1 μm and even most preferably less than 100 nm.

In some embodiments the primary structure is made by an etching process.

In some embodiments the primary nanostructure is characterized by being nanoscopically flat or macroscopically curved with a smooth nanometer length scale surface roughness.

In some embodiments the structuring step comprises an embossing process, where a primary structure is brought in physical contact with the film of ductile ceramic material precursor and pressed into the film of ductile ceramic material precursor, thereby generating an inverse pattern of the primary structure in the film of ductile ceramic material precursor.

In some embodiments the structuring step comprises an embossing step of a structured foil using hydrostatic pressure.

In some embodiments the structuring step comprises a hot embossing process where a heated primary structure is brought in physical contact with the heated film of ductile ceramic material precursor and pressed into the layer of ductile ceramic material precursor, thereby generating an inverse pattern of the primary structure in the film of ductile ceramic material precursor. After generation of the structure, the primary structure and the tool or tool insert comprising the film of structured ductile ceramic material precursor is allowed to cool to a lower temperature in order to make the geometry of the structured layer of ductile ceramic material precursor mechanically stable by increasing the temperature dependent hardness, thereby not deterring it during removal of the primary structure.

In some embodiments the nanostructuring step comprises a step-and-repeat or step-and-flash nano imprint lithography process where a primary structure is brought in physical contact with the film of ductile ceramic material precursor and pressed into the film of ductile ceramic material precursor, thereby generating an inverse pattern of the primary structure in the film of ductile ceramic material precursor. This process is repeated a number of times on different areas on the film of ductile ceramic material precursor. A curing step may be incorporated between each repetition before removal of the primary nanostructure in order to transform the ductile ceramic material precursor into a solid ceramic material, the curing step preferably being an irradiation curing step.

In some embodiments the curing step comprises a thermal curing process where the film of structured ductile ceramic material precursor is heated to a curing temperature for a given period of time, thereby transforming the film of structured ductile ceramic material precursor into a solid structured ceramic material by cross-linking of the ceramic material precursor itself and/or remnants of the ceramic material precursor solvent.

In some embodiments the curing step comprises a plasma curing process where the film of structured ductile ceramic material precursor is subjected to a plasma, the plasma inducing cross-linking of the ceramic material precursor itself and/or remnant ceramic material precursor solvent, thereby transforming the film of ductile ceramic material precursor and/or ceramic material precursor solvent into a structured solid ceramic material.

In some embodiments the curing step comprises an irradiation curing process, where the layer of ductile ceramic material precursor and/or ceramic material precursor solvent is irradiated by ionizing radiation, non-limiting examples being electron beam radiation, UV-radiation, gamma-radiation or x-ray radiation. The ionizing radiation generates free radicals in the ceramic material precursor and/or ceramic material precursor solvent, thereby cross-linking the ductile ceramic material precursor and/or ceramic material precursor solvent to form a solid ceramic material.

In some embodiments the functionalization step comprises a vacuum process where a reactive gas at low pressure is brought in contact with the tool or tool insert comprising the film of solid structured ceramic material, the process preferably being a molecular vapor deposition (MVD) process. The reactive gas is preferably Hexamethyldisiloxane or Hexamethyldisilazane (HMDS), or preferably a silane with a fluoro-carbon-alkane end group, more preferably perfluorodecyltrichlorosilane (FDTS) or perfluorooctyltrichlorosilane FOTS.

In some embodiments the functionalization step comprises a wet chemical process where the tool or tool insert comprising the film of solid structured ceramic material is brought in contact with a reactive liquid substance or a liquid solution of a reactive substance, the reactive substance preferably being a silane with a functional end group, more preferably perfluorodecyltrichlorosilane (FDTS) or perfluorooctyltrichlorosilane FOTS.

In some embodiments the polymer shaping step comprises an injection molding or gas assisted injection molding (blow molding) process. Injection molding is performed by heating a suitable thermoplastic polymer until molten, injecting the molten polymer (and gas in the case of blow molding) into a mold, allowing the polymer to cool and harden, and removing the molded article from the mold. This process may be automated and therefore used to produce a rapid succession of identical articles. The mold used may have means for cooling, in order to increase the speed of solidification of the polymer. A removable shaping surface, e.g. an insert may be incorporated into the mold, and this insert may bear surface micro or nanostructures and/or macroscopic shape that are transferred to the polymer article during the molding process. Alternatively, such structure may be present on the mold so that the mold in itself may be the shaping surface. Such an embodiment may make use of an injection molding mold or mold insert that is made of metal, preferably steel comprising a micro or nanostructured surface made of a solid ceramic material.

In some embodiments the polymer shaping step comprises a compression molding process. Compression molding is performed by heating a suitable polymer until molten in an open mold or mold cavity, closing the mold or mold cavity, thereby compressing the polymer and forcing it to fill all parts of the mold or mold cavity, allowing the polymer to cool and harden, and removing the molded article from the mold. This process may be automated and therefore used to produce a rapid succession of identical articles. The mold used may have means for cooling, in order to increase the speed of hardening of the polymer. A removable shaping surface, e.g. an insert may be incorporated into the mold, and this insert may bear surface micro or nanostructures and/or macroscopic shape that are transferred to the polymer article during the molding process. Alternatively, such structure may be present on the mold so that the mold in itself may be the shaping surface. Such an embodiment may make use of a compression molding mold or mold insert that is made of metal, preferably steel comprising a micro or nanostructured surface made of a solid ceramic material.

In some other embodiments the polymer shaping step comprises a calendering or extrusion process. Calendering and extrusion is a process used to manufacture polymer sheeting. A suitable polymer in pellet form is heated and forced through a series of heated rollers until the polymer sheet reaches the desired dimensions. The sheeting is then passed through cooling rollers in order to cool and set the polymer. Frequently, texture is applied to the polymer sheet during the process, or a strip of fabric is pressed into the back of the polymer sheet to fuse the two together. The calendering process may be used in combination with extrusion—the extruded polymer form may be passed through the heated rollers of the calender as above until the required dimensions are obtained, and then passed over cooling rollers to set the form of the polymer. A calendering roller made of metal is temporarily submerged in the liquid ceramic material precursor solution, where after the roller is spun to ensure the desired precursor film thickness. The roller coated with the precursor film is structured using step-and-repeat NIL. Thereafter the roller is cured by a combination of a plasma and elevated temperature. The cured roller is then functionalized with a fluor-carbon alkane with a reactive end group improving the release properties of the roller. The roller is then used for calendering, whereby the micro or nanostructures defined in the structured layer of solid ceramic material is replicated.

All of the features described may be used in combination so far as they are not incompatible therewith. Thus, spin coating, spray coating, submersion coating, evaporation, embossing, hot embossing, nanoimprint lithography, thermal curing, plasma curing, irradiation curing, vacuum functionalization, wet functionalization, injection molding, blow molding, compression molding and calendering may be used in any combination or combined, e.g. part of the process may be carried by injection molding and part by calendering.

### BRIEF DESCRIPTION OF THE FIGURES

The method and apparatus according to the invention will now be described in more detail with regard to the accompanying figures. The figures show one way of implementing the present invention and is not to be construed as being limiting to other possible embodiments falling within the scope of the attached claim set.

FIG. 1 shows the definition of the directions used in the definition of nanostructures. Length and width are defined as the directions parallel to the local macroscopic geometry, whereas height is defined as the direction perpendicular to the local macroscopic geometry.

FIG. 2 shows an example of the invention, where a curved, concave mold shaping surface comprising a mold used for injection molding or compression molding (A) is coated with a layer of liquid ceramic material precursor solution (B) where the solvent is subsequently allowed to at least partly evaporate forming a thin layer of ductile ceramic precursor (C), which is structured by embossing of a primary nanostructure forming a nanostructured ductile ceramic precursor (D), which is cured by thermal curing forming a shaping surface comprising nanostructured solid ceramic material (E), and said nanostructured shaping surface is used to make a polymeric replica by injection molding (F).

FIG. 3 shows an example of the invention, where a mold shaping surface comprising a roller used for calendering (A) is coated with a layer of liquid ceramic material precursor (B), where the solvent is allowed to at least partly evaporate forming a thin layer of ductile ceramic material precursor (C), which is structured by embossing of a primary nanostructure thereby forming a nanostructured ductile ceramic precursor (D), which is cured by thermal curing thereby forming a solid nanostructured ceramic material (E), which is used to make a polymeric part by calendering (F).

FIG. 4 shows the initial polymer shaping tool (1) with a non-smooth surface characterized by its surface roughness (2).

FIG. 5 shows the initial tool (1) after the coating and evaporation steps resulting in a thin layer of ductile ceramic material precursor (3) with a given a given thickness (4).

FIG. 6 shows the initial tool after the structuring step where a primary nanostructure comprising a topological structure (5) is defined in the surface of the ductile ceramic precursor.

FIG. 7 shows the initial tool (1) after the curing step where the ceramic material precursor has been cured to form a thin layer of a nanostructured ceramic material (6), usable for conventional industrial polymer replication processes.

FIG. 8 shown an example of the invention where a mold shaping surface with surface roughness (A) is coated with a layer of liquid ceramic material precursor solution by spin coating simultaneously smoothening the surface of the liquid ceramic material precursor and evaporating the solvent thereby forming a thin layer of ductile ceramic precursor (B), the ductile ceramic material precursor being subsequently cured to form a solid ceramic material (C), which is used to make a smooth polymeric replica by injection molding (D).

FIG. 9 is a flow-chart of a method according to one aspect of the invention. The dotted steps are optional, whereas the full-line marked steps are required. This method comprises:

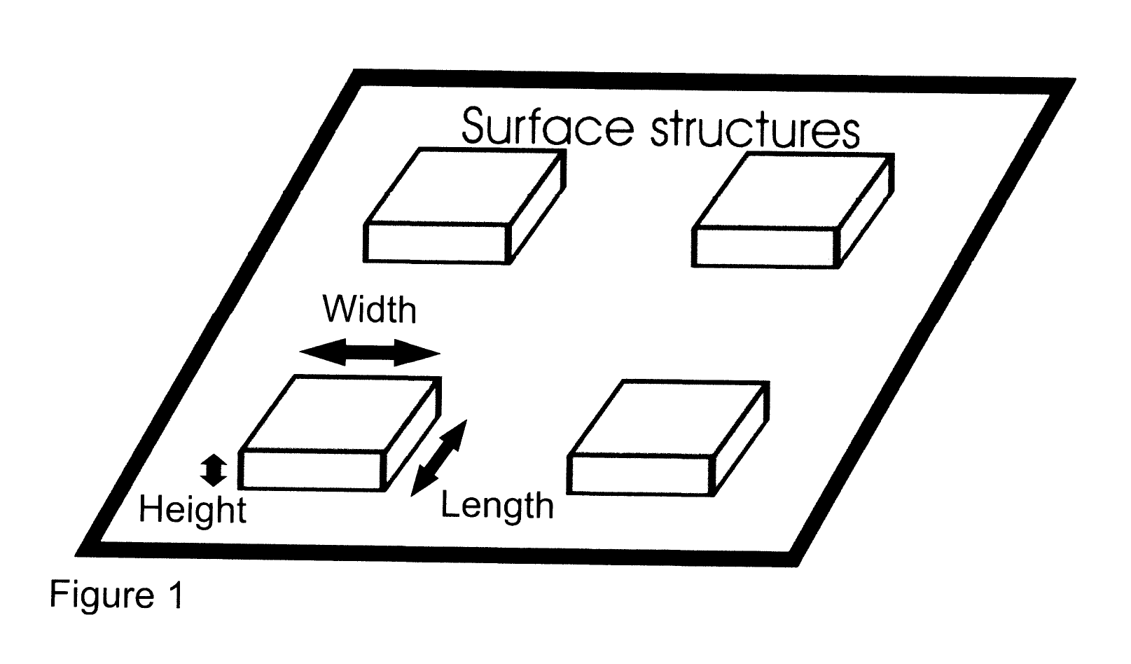

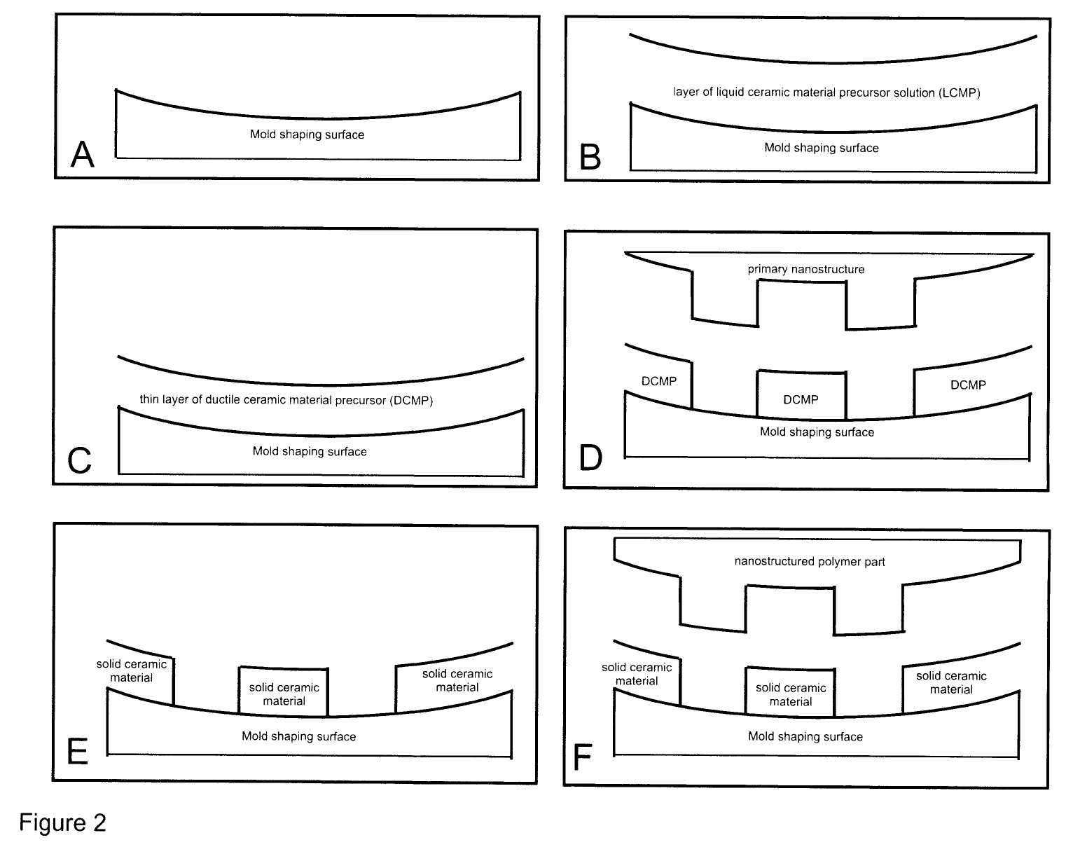

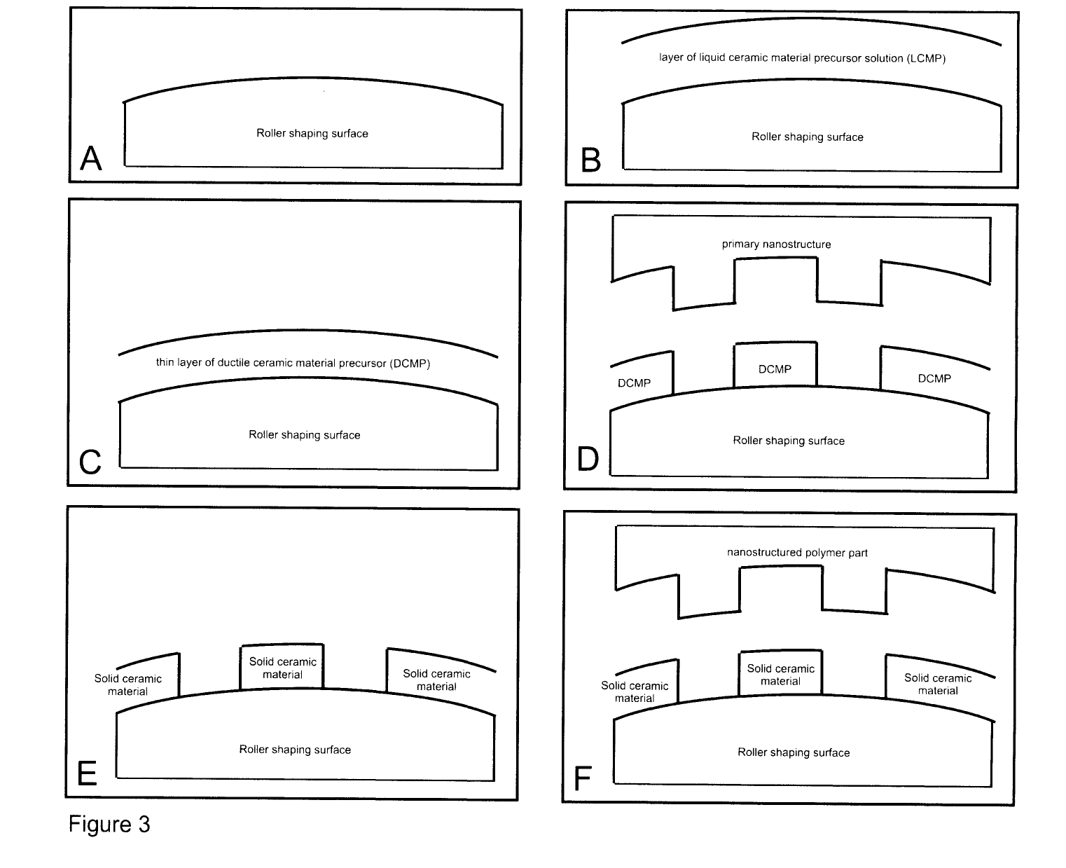

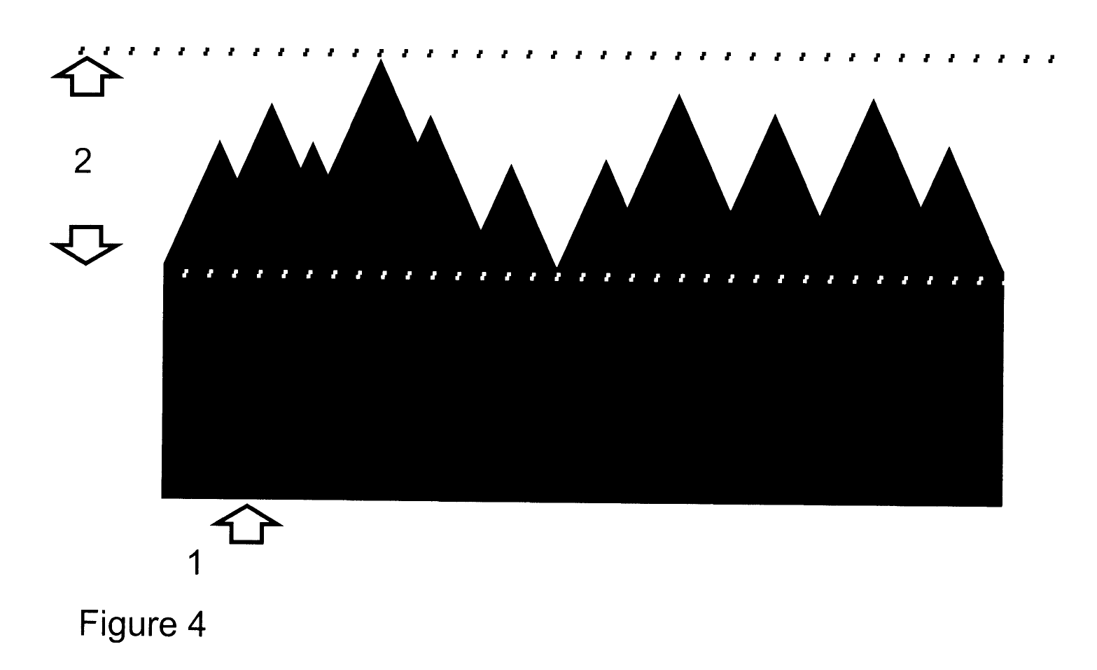

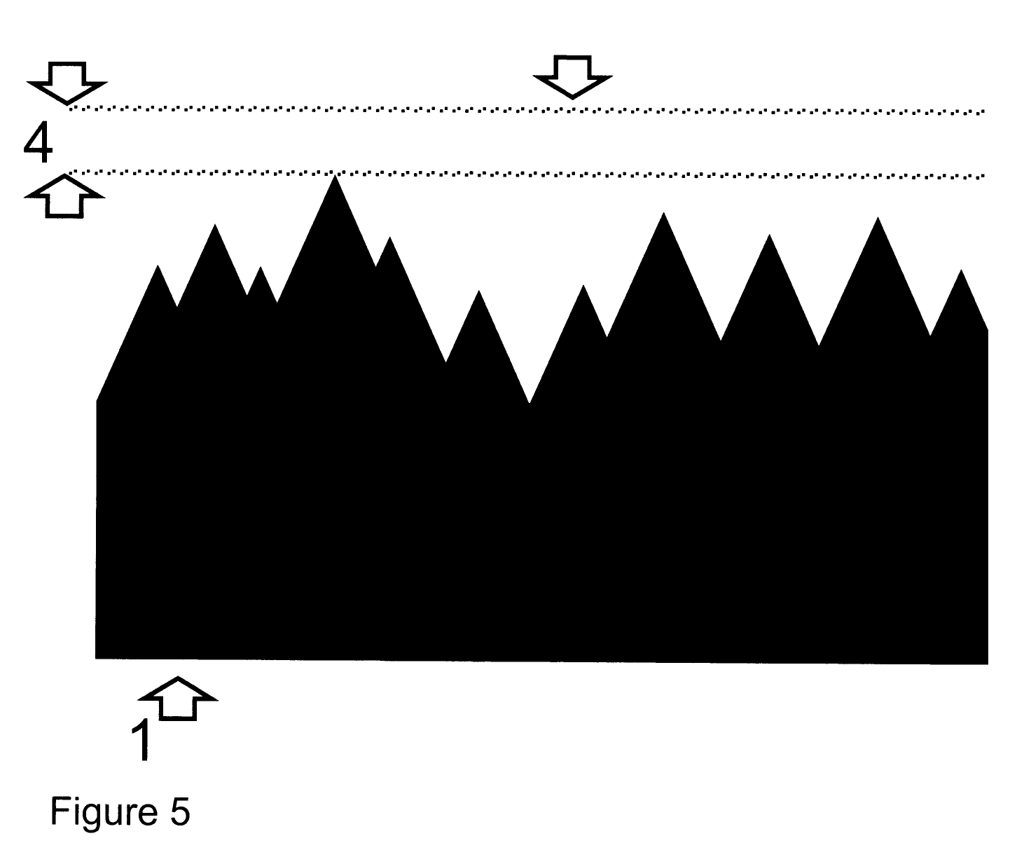

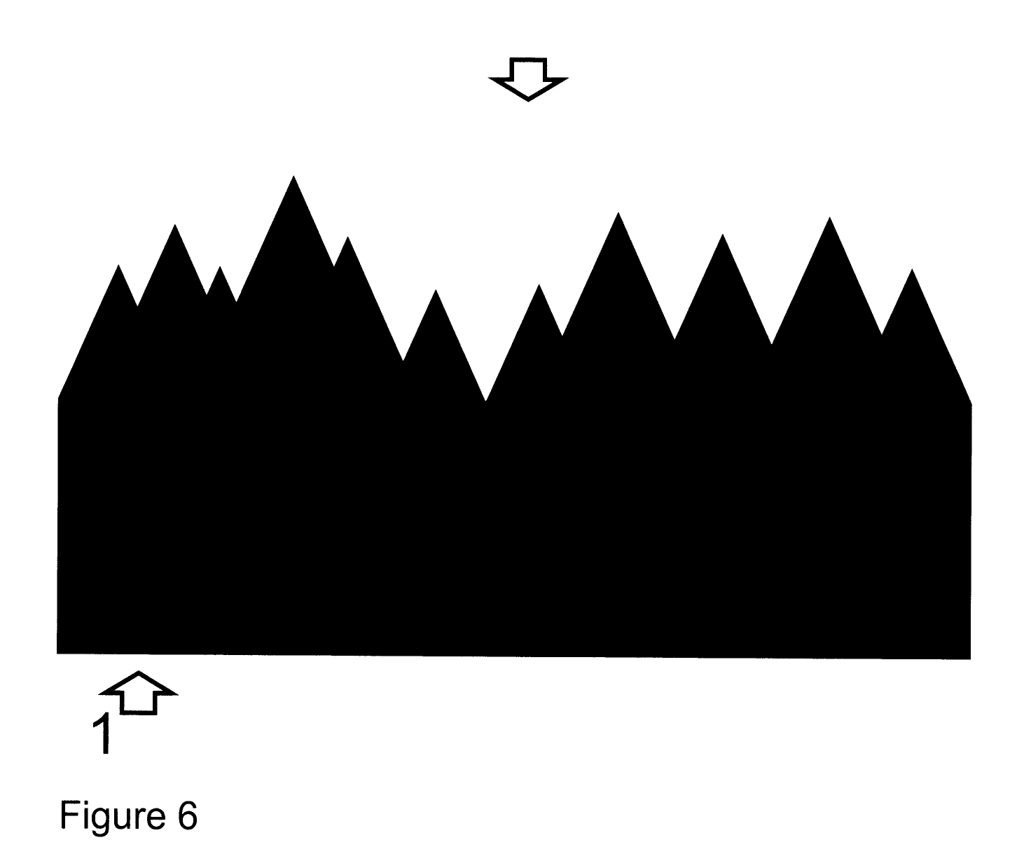

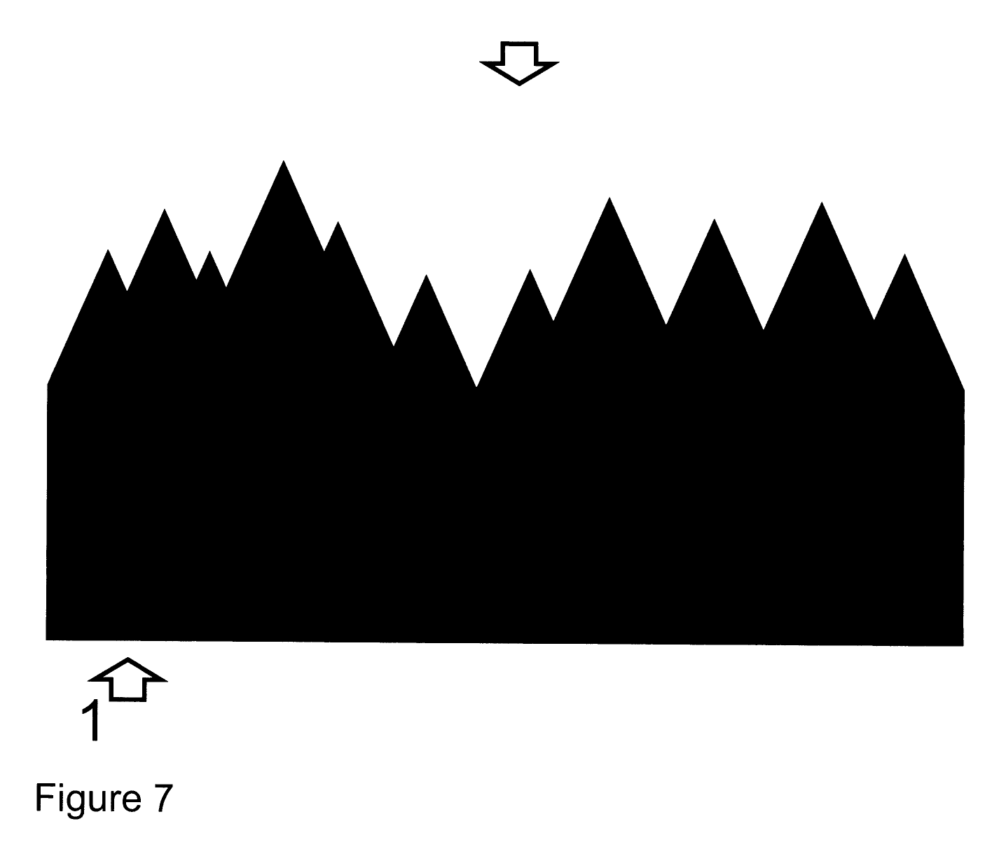

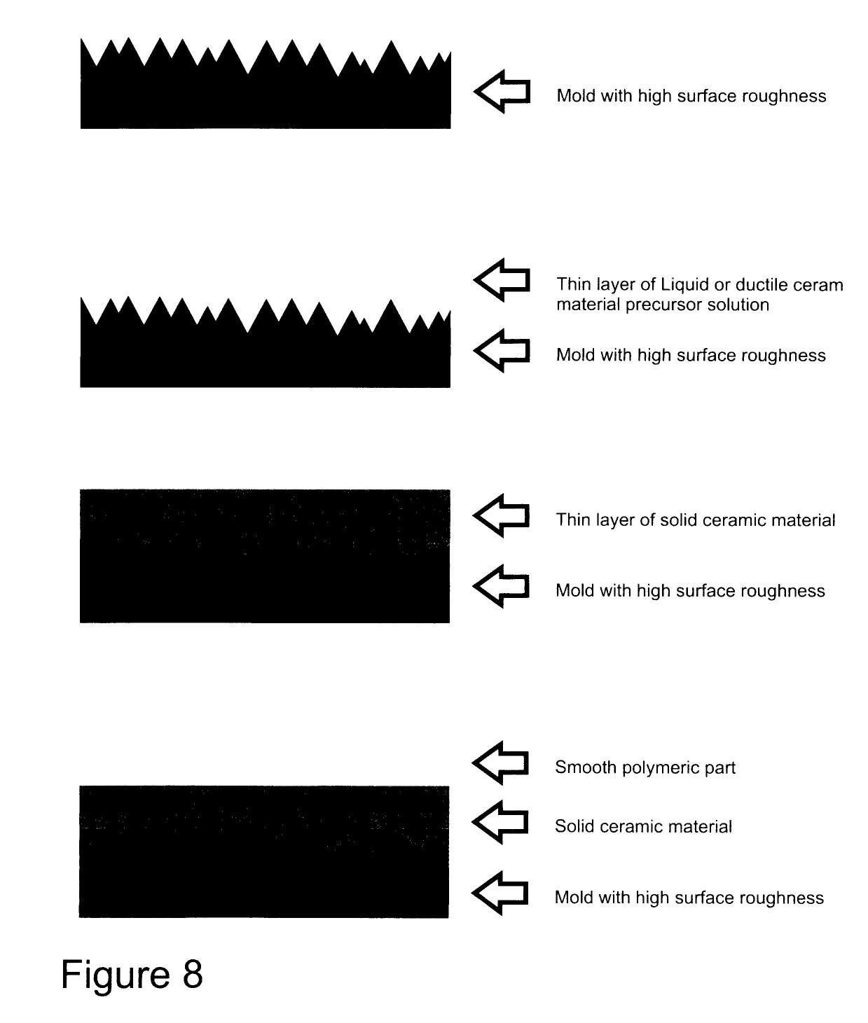

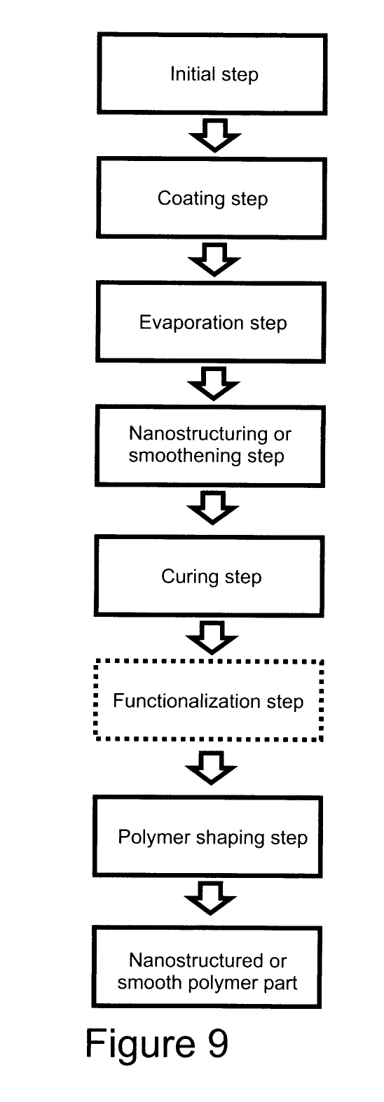

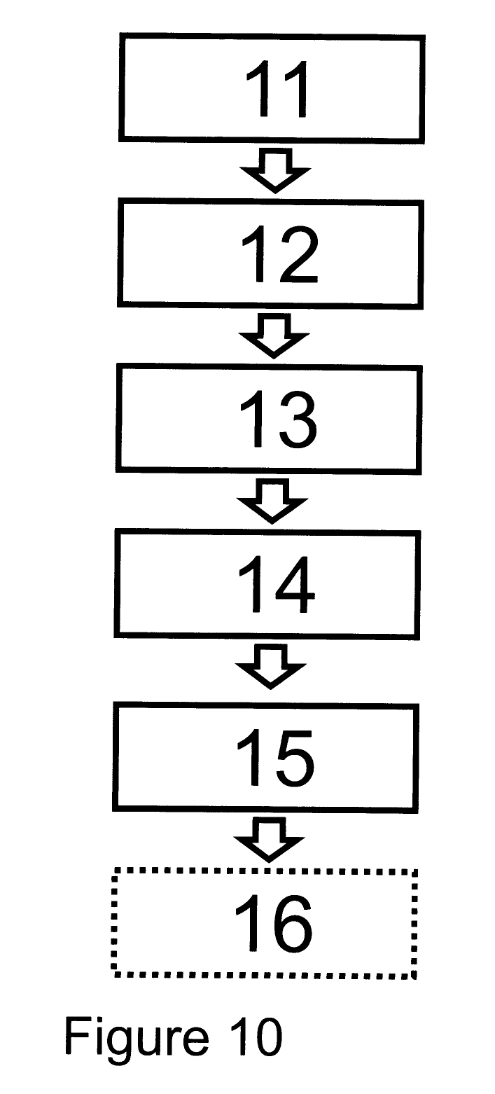

A method for producing a nanostructured polymer article comprising at least one nanostructured surface area, said method comprising at least the following steps:
providing an initial tool for an industrial polymer shaping process
applying a liquid ceramic material precursor solution onto at least one part of a shaping surface of said tool used for shaping of thermoplastic polymers
allowing at least part of the solvent of the liquid ceramic precursor solution to evaporate, thereby forming a ductile, thin film of ceramic material precursor.
generating a nanostructure in said liquid or ductile ceramic material precursor or precursor solution by a structuring step where a primary nanostructure is replicated by physical contact into the said liquid or ductile ceramic material precursor or said precursor solution forming the inverse master structure in the liquid or ductile ceramic material precursor or precursor solution.
curing the said nanostructured liquid or ductile precursor or precursor solution, thereby transforming it into a nanostructured solid ceramic material, which is mechanically and thermally stable to the conditions of the subsequent polymer shaping step.
optionally functionalizing the surface of the solid ceramic material
bringing heated molten thermoplastic polymer in contact with the nanostructured tool, comprising the nanostructured solid ceramic material on the shaping surface, maintained at a temperature lower than the solidification temperature of the said polymer, and allowing the molten polymer to solidify in order to form the said nanostructured polymer article.

FIG. 10 shows a flow-chart of a method for making the device or tool used to make nanostructured polymer replicas using conventional polymer replication techniques, according to one aspect of the invention. The dotted steps are optional, whereas the full-line marked steps are required. An initial polymer shaping tool with a surface roughness unsuitable for defining nanostructures due to a high surface roughness (11) is coated with a liquid ceramic material precursor solution (12), the solvent is allowed to at least partly evaporate (13) forming a ductile film of ceramic material precursor, the ductile film of ceramic material precursor is structures by a mechanical structuring step (14), the structured film of ductile ceramic material precursor is cured (15) to form a solid, hard ceramic material, which may optionally be conveniently surface treated (16) to obtain a function of either reduces de-molding forces and/or improved replication abilities by controlling the surface energy to the molten and solidified polymer, respectively.

### DETAILED DESCRIPTION OF AN EMBODIMENT

In a first example a mold insert is made of steel, and the liquid ceramic material precursor is HSQ dissolved in MIBK (FOx-17 from Corning). FOx-17 is coated onto a 200 nm surface roughness polished planar stainless steel surface using spin coating at 200 RPM for 15 s, forming a ductile HSQ film. A primary nanostructure made of nickel by the well-known LIGA (Lithography and Galvanoforming) method comprising a diffraction grating with a depth of 500 nm and a period of 700 nm is embossed at a pressure of 25 kg/cm² in the ductile HSQ film, making a negative image of the primary nanostructure. The mold insert is cured at 600° C. for one hour, transforming the ductile nanostructured HSQ film into a solid ceramic material, primarily consisting of SiO₂. The cured mold insert is coated by a self assembled monolayer of perfluorodecyltrichlorosilane (FDTS) by a molecular vapor deposition process. The mold insert is then used for injection molding of 1 mm thick polystyrene replicas at a melt temperature of 250° C., a mold temperature of 40° C., a cycle time of 28 s and an injection velocity (linear filling velocity over the nanostructures) of 2 m/s on a 25T injection molding machine, whereby the nanostructures defined in the nanostructured layer of solid ceramic material is replicated into the polystyrene replicas.

In a second example a mold insert is made of nickel by electroplating with a surface roughness of 5 nm, and the liquid ceramic material precursor is HSQ dissolved in MIBK (FOx-12 from Corning). FOx-12 is coated onto the electroplated nickel surface using spin coating at 200 RPM for 15 s, forming a ductile HSQ film. A primary nanostructure made of polycarbonate by injection molding comprising a diffraction grating with a depth of 600 nm and a period of 650 nm is embossed at a pressure of 25 kg/cm² in the ductile HSQ film, making a negative image of the primary nanostructure. The mold insert is cured at 600° C. for one hour subsequently cured by air plasma (100 W, 5 minutes), transforming the ductile nanostructured HSQ film into a solid ceramic material, primarily consisting of SiO₂. The cured mold insert is coated by a monolayer of Hexamethyldisiloxane (HMDS) by a in a vacuum oven process. The mold insert is then used for injection molding polystyrene replicas at a melt temperature of 250° C., a mold temperature of 40° C., a cycle time of 28 s, and an injection velocity (linear filling velocity over the nanostructures) of 2 m/s on a 25T injection molding machine, whereby the nanostructures defined in the nanostructured layer of solid ceramic material is replicated into the polystyrene replicas.

In a third example a roller made of polished stainless steel (diameter 50 mm, surface roughness 100 nm) is partly submerged in the liquid ceramic material precursor HSQ dissolved in MIBK (FOx-17 from Corning) and rotated until all shaping parts of the roller has been in contact with FOx-12. The roller is spun at 50 RPM for 5 minutes ensuring an evenly distribution of a ductile layer of HSQ on the roller. A primary nanostructure comprising photonic crystal structures made of quartz by lithography and reactive ion etching with subsequent coating with a slip layer of FDTS is used to make step-and-repeat nano imprint lithography on the whole roller surface. The roller is cured at 600° C. for one hour subsequently cured by an air plasma (100 W, 5 minutes), transforming the ductile nanostructured HSQ film into a solid ceramic material, primarily consisting of SiO₂. The cured mold insert is coated by a self assembled monolayer of perfluorodecyltrichlorosilane (FDTS) by a molecular vapor deposition process. The roller is then used for calendering a polyethylene film, whereby the nanostructures defined in the nanostructured layer of solid ceramic material is replicated into the polyethylene film.

In a fourth example a mold insert is made of steel by electric discharge manufacturing and subsequent manual polishing to a surface roughness of 3 μm comprising the shaping surface for the outer surface of a gelatin capsule. The liquid ceramic material precursor is HSQ dissolved in MIBK (FOx-17 from Corning). FOx-17 is coated on the mold insert using spray coating, forming a ductile HSQ film after evaporation of the MIBK solvent for 5 minutes. A primary nanostructure made of nickel comprising a radius 1 mm identificational nanostructure comprising both microscopic and nanoscopic features, as well as optical properties recognizable by the eye, is embossed in the ductile HSQ film at a pressure of 100 kg/cm² in the HSQ film, making a negative image of the primary nanostructure. The mold insert is cured at 600° C. for one hour subsequently cured by air plasma (100 W, 5 minutes), transforming the ductile nanostructured HSQ film into a solid ceramic material, primarily consisting of SiO₂. The cured mold insert is coated by a self assembled monolayer of perfluorodecyltrichlorosilane (FDTS) by a molecular vapor deposition process. The mold insert is then used for blow molding of gelatin capsules with an integrated identificational marker.

In a fifth example a planar mold insert is made by steel and polished to a surface roughness of 1 μm. The surface of the mold insert is spin coated with FOx-17 at 3000 RPM for 60 s, ensuring filling of the structures in the steel mold insert comprising the surface roughness, resulting in a smooth surface layer of HSQ with a surface roughness of less than 10 nm. The mold insert is thereafter cured at 600° C. for 1 hour, and subsequently functionalized by FDTS in an MVD process. The cured and functionalized mold insert is used in an injection molding process for making polystyrene parts with a surface roughness of less than 10 nm.

In a sixth example a mold insert comprising a curvature radius of 100 mm is polished to a surface roughness of 3 μm. The surface of the mold insert is spray coated with a 10 μm thick layer of FOx-17 ensuring filling of the structures in the steel mold insert comprising the surface roughness. The FOx-17 layer is embossed with a 300 μm thick convex (radius 100 mm) nickel stamp coated with FDTS, with a surface roughness of less than 5 nm using hydrostatic pressure. This ensures contact between the FOx-17 layer and the FDTS coated nickel stamp in all areas, thereby smoothening the surface of the FOx-17 layer to a surface roughness of less than 5 nm. The mold insert is cured at 600° C. for one hour. The insert is used in a standard injection molding process making COC parts with a surface roughness of less than 5 nm.

In a seventh example a mold insert comprising the shape of a medical pill or tablet with a radius of curvature of 5 mm is polished to a surface roughness of 3 μm. The surface of the mold is spray coated with a 10 μm thick layer of FOx-17 ensuring filling of the structures in the steel mold insert comprising the surface roughness. The FOx-17 layer is embossed with a 30 μm thick elastic polymer foil deformed to radius 5 mm by hydrostatic pressure, with a 1 mm radius circular identificational nanostructure comprising both microscopic and nanoscopic features, as well as optical properties recognizable by the eye, is embossed in the ductile HSQ film at a pressure of 100 kg/cm² in the HSQ film, making a negative image of the primary nanostructure. The mold insert is cured at 600° C. for one hour subsequently cured by air plasma (100 W, 5 minutes), transforming the ductile nanostructured HSQ film into a solid ceramic material, primarily consisting of SiO₂. The cured mold insert is coated by a self assembled monolayer of perfluorodecyltrichlorosilane (FDTS) by a molecular vapor deposition process. The mold insert is then used for injection molding of a medical drug mixed with a polymer matrix substance to produce pills with an integrated identifier and counterfeit preventive marker.

In an eight example a flat ejector pin with a radius of 1.5 mm and a surface roughness of 3 μm is spin coated with FOx-17 at 1000 RPM for 10 s, resulting in a film of ductile HSQ. The ejector pin is embossed with a diffraction grating made of nickel by the well-known LIGA method. The diffraction grating is 500 nm deep and has a period of 700 nm. The diffraction grating structure is replicated into the ductile HSQ. The ejector pin is cured at 600° C. for one hour where the ductile layer of HSQ is transformed into a solid ceramic substance. After curing, the mold insert is then used for injection molding polystyrene replicas at a melt temperature of 250° C., a mold temperature of 40° C., a cycle time of 28 s, and an injection velocity (linear filling velocity over the nanostructures) of 2 m/s on a 25T injection molding machine, whereby the nanostructures defined in the nanostructured layer of solid ceramic material is replicated into the polystyrene replicas.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

All patents and non-patent references cited in the present application are also hereby incorporated by reference in their entirety.

1. A method for producing a nanostructured polymer article comprising at least one nanostructured surface area, said method comprising at least the following steps:
providing an initial tool for an industrial polymer shaping process
applying a liquid ceramic material precursor solution onto at least one part of a shaping surface of said tool used for shaping of thermoplastic polymers
allowing at least part of the solvent of the liquid ceramic precursor solution to evaporate, thereby forming a ductile, thin film of ceramic material precursor.
generating a nanostructure in said liquid or ductile ceramic material precursor or precursor solution by a structuring step where a primary nanostructure is replicated by physical contact into the said liquid or ductile ceramic material precursor or said precursor solution forming the inverse master structure in the liquid or ductile ceramic material precursor or precursor solution.
curing the said nanostructured liquid or ductile precursor or precursor solution, thereby transforming it into a nanostructured solid ceramic material, which is mechanically and thermally stable to the conditions of the subsequent polymer shaping step.
bringing heated molten thermoplastic polymer in contact with the nanostructured tool, comprising the nanostructured solid ceramic material on the shaping surface, maintained at a temperature lower than the solidification temperature of the said polymer, and allowing the molten polymer to solidify in order to form the said nanostructured polymer article.

2. A method according for producing a smooth polymer article comprising a surface roughness less than preferably 250 nm, more preferably less than 100 nm, even more preferably less than 20 nm and most preferably less than 5 nm comprising at least the following steps:
providing an initial tool for an industrial polymer shaping process
applying a thin film of liquid or ductile ceramic material precursor or precursor solution onto at least one part of a shaping surface of a mold or mold insert used for shaping of thermoplastic polymers.
smoothening the liquid or ductile ceramic material precursor or precursor solution by mechanical means such as, but not limited to, embossing, polishing spinning, spontaneous smoothing by the means of gravity or surface tension, until a surface roughness of the liquid or ductile ceramic material precursor or precursor solution of less than preferably 5 nm, more preferably less than 10 nm, even more preferably less than 20 nm and most preferably less than 50 nm is obtained
curing the said liquid or ductile ceramic material precursor or precursor solution, thereby transforming it into a smooth solid ceramic material, which is mechanically and thermally stable to the conditions of the subsequent polymer shaping step.
bringing heated molten thermoplastic polymer in contact with the smooth tool, comprising the smooth shaping surface, maintained at a temperature lower than the solidification temperature of the said polymer, and allowing the molten polymer to solidify in order to form the said smooth polymer article.

3. A method according to claim 1 and 2 where the surface topography of the said initial tool shaping surface is non-smooth, defined by the surface being characterized by a surface roughness Rz of more than 500 nm, or preferably more than 300 nm, more preferably more than 100 nm, even more preferably more than 50 nm and most preferably more than 20 nm.

4. A method according to claim 1-3 where the macroscopic geometry of the said initial tool shaping surface is non-planar.

5. A method according to claim 1-4 where the said application of the liquid ceramic material precursor solution is done by spray coating or spin coating

6. A method according to claim 1-4 where the said application of the liquid or ductile ceramic material precursor or precursor solution is done by at least partly submersion of the mold or mold insert into the said precursor or precursor solution, subsequently removing the mold or mold insert from said precursor or precursor solution, subsequently removing excess precursor or precursor solution by mechanical means, such as but not limited to gravity, rotation of the mold or mold insert or blow drying with a compressed gas.

8. A method according to any previous claims where the structuring step is an embossing process, which takes place at ambient temperature or takes place at an elevated temperature below the curing temperature of the ceramic material precursor.

9. A method according to any previous claims where the structuring step comprises embossing of the nanostructure is repeated more than once.

10. A method according to any previous claims where the curing is a thermal curing, a plasma curing or an ionizing radiation curing or a combination thereof.

11. A method according to any preceding claims comprising
the liquid ceramic precursor primarily consisting of hydrogen silsesquioxane (HSQ), methyl silsesquioxane (MSQ) or a mixture thereof and the solvent consisting of a volatile organic solvent.
the curing step being a thermal curing at a temperature between 300° C. and 800° C.

12. A method according to claims 2-11 where the smoothening is done after the curing step.

13. A method according to any preceding claims where the cured mold or mold insert comprising a layer of nanostructured or smooth solid ceramic material is coated with a chemically functional substance such as, but not limited to, perfluorodecyltrichlorosilane (FDTS), perfluorooctyltrichlorosilane FOTS, or Hexamethyldisilazane or Hexamethyldisiloxane (HMDS) covalently bound to the solid nanostructured ceramic material.

14. The method according to any of the preceding claims wherein said polymer article is produced by injection molding, gas assisted injection molding, blow molding, compression molding or calendering, extrusion, deep drawing or coining.

15. The method according to any of the previous claims where the nanostructure of the polymer part induces functionality, such as, but not limited to, making the surface self cleaning, decorative, identificational or information containing, biologically or optically functional, or making the surface have a certain tactility.

16. The method according to any of the previous claims where the polymer is acrylonitrile butadiene styrene (ABS), acrylic, celluloid, cellulose acetate, Ethylene-Vinyl Acetate (EVA), Ethylene vinyl alcohol (EVAL), Fluoroplastics, Gelatin, Liquid Crystal Polymer (LCP), cyclic oleofin copolymer (COC), polyacetal, polyacrylate, polyacrylonitrile, polyamide, polyamide-imide (PAI), polyaryletherketone, polybutadiene, polybutylene, polybutylene therephthalate, polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoates (PHAs), polyketone (PK), polyester, polyethylene (PE), polyetheretherketone (PEEK), polyetherimide (PEI), polyethersulfone (PES), Polyethylenechlorinates (PEC), polyimide (PI), polylactic acid (PLA), Polymethylpentene (PMP), polyphenylene oxide (PPO), polyphenylene sulfide (PPS), polyphthalamide (PPA), polypropylene (PP), polystyrene (PS), polysulfone (PSU), polyurethane (PU), polyvinyl acetate (PVA), polyvinyl chloride (PVC), polyvinylidene chloride (PVDC) and styrene-acrylonitrile (SAN), a polymer matrix substance for a medical drug, or mixes or copolymers thereof.

17. A nanostructured or smooth polymer article made by any of the preceding claims.

18. A nanostructured or smooth solid ceramic material shaping surface on a polymer shaping tool made by any of the preceding claims.
